(19) United States
(12) Patent Application Publication
(10) Pub. No.: US 2022/0106510 A1
(43) Pub. Date: Apr. 7, 2022

(54) COMPOSITION CONTAINING REFRIGERANT, USE OF SAME, REFRIGERATOR COMPRISING THE SAME, AND METHOD FOR OPERATING SAID REFRIGERATOR

(71) Applicant: DAIKIN INDUSTRIES, LTD., Osaka (JP)

(72) Inventors: Mitsushi ITANO, Osaka (JP); Shun OHKUBO, Osaka (JP); Daisuke KARUBE, Osaka (JP)

(73) Assignee: DAIKIN INDUSTRIES, LTD., Osaka (JP)

(21) Appl. No.: 17/551,757

(22) Filed: Dec. 15, 2021

Related U.S. Application Data
(63) Continuation of application No. PCT/JP2020/024132, filed on Jun. 19, 2020.

(30) Foreign Application Priority Data
Jun. 19, 2019 (JP) 2019-114163
Jan. 29, 2020 (JP) 2020-012937

(51) Int. Cl. C09K 5/04

(52) U.S. Cl. CPC C09K 5/045

(57) ABSTRACT

An object of the present disclosure is to provide a novel low-GWP mixed refrigerant. The present disclosure provides a composition comprising a refrigerant, the refrigerant comprising trans-1,2-difluoroethylene (HFO-1132(E)), difluoromethane (R32), and 1,3,3,3-tetrafluoropropene (R1234ze).

### TECHNICAL FIELD

The present disclosure relates to a composition comprising a refrigerant, use of the composition, a refrigerating machine having the composition, and a method for operating the refrigerating machine.

### BACKGROUND ART

R410A is currently used as an air conditioning refrigerant for home air conditioners etc. R410A is a two-component mixed refrigerant of difluoromethane (CH₂F₂: HFC-32 or R32) and pentafluoroethane (C₂HF₅: HFC-125 or R125), and is a pseudo-azeotropic composition.

However, the global warming potential (GWP) of R410A is 2088. Due to growing concerns about global warming, R32, which has a GWP of 675, has been increasingly used.

For this reason, various low-GWP mixed refrigerants that can replace R410A have been proposed (PTL 1).

### CITATION LIST

### Patent Literature

PTL 1: WO2015/141678

### SUMMARY

A composition comprising a refrigerant, the refrigerant comprising trans-1,2-difluoroethylene (HFO-1132(E)), difluoromethane (R32), and 1,3,3,3-tetrafluoropropene (R1234ze).

### Advantageous Effects

The refrigerant according to the present disclosure has a low GWP.

### BRIEF DESCRIPTION OF DRAWINGS

FIG. 1 is a schematic view of an apparatus used in a flammability test.

FIG. 2 is a diagram showing points A to S, U, and V, and line segments that connect these points to each other in a ternary composition diagram in which the sum of HFO-1132(E), R32, and R1234ze is 100 mass %.

FIG. 3 is a diagram showing point K_{r=0.2}, point L_{r=0.2}, point M_{r=0.2}, point N_{r=0.2}, point B″_{r=0.2}, point J_{r=0.2}, point I_{r=0.2}, point H_{r=0.2}, point G_{r=0.2} point O_{r=0.2}, point P_{r=0.2}, point Q_{r=0.2}, point R_{r=0.2}, point S_{r=0.2}, and point V_{r=0.2}, and line segments that connect these points to each other in a ternary composition diagram whose first vertex represents HFO-1132(E), second vertex represents R32, and third vertex represents the sum of 1234ze and R1234yf when the sum of HFO-1132(E), R32, R1234ze, and R1234yf is 100 mass %, and when r=R1234yf/(R1234ze+R1234yf)=0.2.

FIG. 4 is a diagram showing point K_{r=0.27}, point L_{r=0.27}, point M_{r=0.27}, point N_{r=0.27}, point B″_{r=0.27}, point J_{r=0.27}, point H_{r=0.27}, point G_{r=0.27}, point O_{r=0.27}, point P_{r=0.27}, point Q_{r=0.27}, point R_{r=0.27}, point S_{r=0.27}, and point V and line segments that connect these points to each other in a ternary composition diagram whose first vertex represents HFO-1132(E), second vertex represents R32, and third vertex represents the sum of 1234ze and R1234yf when the sum of HFO-1132(E), R32, R1234ze, and R1234yf is 100 mass %, and when r=R1234yf/(R1234ze+R1234yf)=0.27.

FIG. 5 is a diagram showing point K_{r=0.5}, point L_{r=0.5}, point M_{r=0.5}, point N_{r=0.5}, point B″_{r=0.5}, point J_{r=0.5}, point H_{r=0.5}, point G_{r=0.5}, point O_{r=0.5}, point P_{r=0.5}, point Q_{r=0.5}, point R_{r=0.5}, point S_{r=0.5}, and point V_{r=0.5}, and line segments that connect these points to each other in a ternary composition diagram whose first vertex represents HFO-1132(E), second vertex represents R32, and third vertex represents the sum of 1234ze and R1234yf when the sum of HFO-1132(E), R32, R1234ze, and R1234yf is 100 mass %, and when r=R1234yf/(R1234ze+R1234yf)=0.5.

FIG. 6 is a diagram showing point K_{r=0.64}, point L_{r=0.64}, point M_{r=0.64}, point N_{r=0.64}, point B″_{r=0.64}, point J_{r=0.64}, point H_{r=0.64}, point G_{r=0.64}, point O_{r=0.64}, point P_{r=0.64}, point Q_{r=0.64}, point R_{r=0.64}, point S_{r=0.64}, and point V and line segments that connect these points to each other in a ternary composition diagram whose first vertex represents HFO-1132(E), second vertex represents R32, and third vertex represents the sum of 1234ze and R1234yf when the sum of HFO-1132(E), R32, R1234ze, and R1234yf is 100 mass %, and when r=R1234yf/(R1234ze+R1234yf)=0.64.

FIG. 7 is a diagram showing point K_{r=0.82}, point L_{r=0.82}, point M_{r=0.82}, point N_{r=0.82}, point B″_{r=0.82}, point J_{r=0.82}, point H_{r=0.82}, point G_{r=0.82}, point O_{r=0.82}, point P_{r=0.82}, point Q_{r=0.82}, point R_{r=0.82}, point S_{r=0.82}, and point V_{r=0.82}, and line segments that connect these points to each other in a ternary composition diagram whose first vertex represents HFO-1132(E), second vertex represents R32, and third vertex represents the sum of 1234ze and R1234yf when the sum of HFO-1132(E), R32, R1234ze, and R1234yf is 100 mass %, and when r=R1234yf/(R1234ze+R1234yf)=0.82.

FIG. 8 is a diagram showing point K_{r=1.0}, point L_{r=1.0}, point M_{r=1.0}, point N_{r=1.0}, point B″_{r=1.0}, point J_{r=1.0}, point H_{r=1.0}, point G_{r=1.0}, point O_{r=1.0}, point P_{r=1.0}, point Q_{r=1.0}, point R_{r=1.0}, point S_{r=1.0}, and point V_{r=1.0}, and line segments that connect these points to each other in a ternary composition diagram whose first vertex represents HFO-1132(E), second vertex represents R32, and third vertex represents the sum of 1234ze and R1234yf when the sum of HFO-1132 (E), R32, R1234ze, and R1234yf is 100 mass %, and when r=R1234yf/(R1234ze+R1234yf)=1.0.

### DESCRIPTION OF EMBODIMENTS

The present inventors conducted intensive studies to solve the above problems, and consequently found that a mixed refrigerant comprising trans-1,2-difluoroethylene (HFO-1132(E)), difluoromethane (R32), and 1,3,3,3-tetrafluoropropene (R1234ze) has the above properties.

The present disclosure has been completed as a result of further research based on this finding. The present disclosure includes the following embodiments.

### Definition of Terms

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC). Non-fluorocarbon compounds include propane (R290), propylene (R1270), butane (R600), isobutane (R600a), carbon dioxide (R744), ammonia (R717), and the like.

In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”

In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller.

The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.

In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.

In the present specification, a refrigerant having “WCF lower flammability” means that the most flammable composition (worst case of formulation for flammability: WCF) has a burning velocity of 10 cm/s or less according to the US ANSI/ASHRAE Standard 34-2013. Further, in the present specification, a refrigerant having “ASHRAE lower flammability” means that the burning velocity of WCF is 10 cm/s or less, that the most flammable fraction composition (worst case of fractionation for flammability: WCFF), which is specified by performing a leakage test during storage, shipping, or use based on ANSI/ASHRAE 34-2013 using WCF, has a burning velocity of 10 cm/s or less, and that the flammability classification according to the US ANSI/ASHRAE Standard 34-2013 is determined to be classified as “Class 2L.”

### 1. Refrigerant

### 1.1 Refrigerant Component

The refrigerant according to the present disclosure comprises trans-1,2-difluoroethylene (HFO-1132(E)), difluoromethane (R32), and 1,3,3,3-tetrafluoropropene (R1234ze).

The refrigerant according to the present disclosure has a low GWP.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NB″, B″J, JI, IH, HG, and GK that connect the following 9 points:

point K (72.0, 0.0, 28.0),
point L (48.6, 18.1, 33.3),
point M (35.7, 36.7, 27.6),
point N (28.9, 51.6, 19.5),
point B″ (0.0, 51.4, 48.6),
point J (0.0, 39.1, 60.9),
point I (2.7, 36.5, 60.8),
point H (24.3, 18.0, 57.7), and
point G (50.9, 0.0, 49.1),
or on the line segments KL, LM, MN, NB″, JI, IH, and HG (excluding point B″, point J, point G, and point K),

the line segments LM, MN, NB″, B″J, JI, IH, and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433). When the requirements above are satisfied, the refrigerant according to the present disclosure has a refrigerating capacity ratio of 70% or more relative to that of R410A, and a GWP of 350 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LM, MI, IH, HG, and GK that connect the following 6 points:

point K (72.0, 0.0, 28.0),
point L (48.6, 18.1, 33.3),
point M (35.7, 36.7, 27.6),
point I (2.7, 36.5, 60.8),
point H (24.3, 18.0, 57.7), and
point G (50.9, 0.0, 49.1),
or on the line segments KL, LM, MI, IH, and HG (excluding point G and point K),

the line segments LM, MI, IH, and GK are straight lines,

coordinates (x,y,z) of the points on the line segment KL are represented by (x, 0.0114x−2.1454x+95.397, −0.0114x°+1.1454x+4.603), and

coordinates (x,y,z) of the points on the line segment HG are represented by (x, 0.00319x²−0.9195x+38.567, −0.00319x²−0.0805x+61.433). When the requirements above are satisfied, the refrigerant according to the present disclosure has a refrigerating capacity ratio of 70% or more relative to that of R410A, and a GWP of 250 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LH, HG, and GK that connect the following 4 points:

point K (72.0, 0.0, 28.0),
point L (48.6, 18.1, 33.3),
point H (24.3, 18.0, 57.7), and
point G (50.9, 0.0, 49.1),
or on the line segments KL, LH, and HG (excluding point G and point K),

the line segments LH and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²-0.0805x+61.433). When the requirements above are satisfied, the refrigerant according to the present disclosure has a refrigerating capacity ratio of 70% or more relative to that of R410A, and a GWP of 125 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NF, FE, ED, DC, and CK that connect the following 8 points:

point K (72.0, 0.0, 28.0),
point L (48.6, 18.1, 33.3),
point M (35.7, 36.7, 27.6),
point N (28.9, 51.6, 19.5),
point F (1.0, 51.5, 47.5),
point E (16.7, 36.5, 46.8),
point D (39.8, 18.1, 42.1), and
point C (67.6, 0.0, 32.4),
or on the line segments KL, LM, MN, NF, FE, ED, and DC (excluding point C and point K),

the line segments LM, MN, NF, FE, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x′−0.0739x+49.097). When the requirements above are satisfied, the refrigerant according to the present disclosure has a refrigerating capacity ratio of 80% or more relative to that of R410A, and a GWP of 350 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LM, ME, ED, DC, and CK that connect the following 6 points:

point K (72.0, 0.0, 28.0),
point L (48.6, 18.1, 33.3),
point M (35.7, 36.7, 27.6),
point E (16.7, 36.5, 46.8),
point D (39.8, 18.1, 42.1), and
point C (67.6, 0.0, 32.4),
or on the line segments KL, LM, ME, ED, and DC (excluding point C and point K),

the line segments LM, ME, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097). When the requirements above are satisfied, the refrigerant according to the present disclosure has a refrigerating capacity ratio of 80% or more relative to that of R410A, and a GWP of 250 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by line segments KL, LD, DC, and CK that connect the following 4 points:

point K (72.0, 0.0, 28.0),
point L (48.6, 18.1, 33.3),
point D (39.8, 18.1, 42.1), and
point C (67.6, 0.0, 32.4),
or on the line segments KL, LD, and DC (excluding point C and point K),

the line segments LD and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097). When the requirements above are satisfied, the refrigerant according to the present disclosure has a refrigerating capacity ratio of 80% or more relative to that of R410A, and a GWP of 125 or less, and further ensures a WCF lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132(E), R32, and R1234ze is 100 mass % are within the range of a figure surrounded by straight lines VR, RS, SB″, B″J, JI, and IV that connect the following 6 points:

point V (17.1, 24.2, 58.7),
point R (16.1, 36.6, 47.3),
point S (15.9, 51.4, 32.7),
point B″ (0.0, 51.4, 48.6),
point J (0.0, 39.1, 60.9), and
point I (2.7, 36.5, 60.8),
or on the straight lines VR, RS, SB″, JI, and IV (excluding point B″ and point J). When the requirements above are satisfied, the refrigerants according to the present disclosure have a refrigerating capacity ratio of 70% or more relative to that of R410A, and further ensures an ASHRAE lower flammability.

The refrigerant according to the present disclosure is preferably a refrigerant wherein

when the mass % of HFO-1132(E), R32, and R1234ze based on their sum is respectively represented by x, y, and z, coordinates (x,y,z) in a ternary composition diagram in which the sum of HFO-1132 (E), R32, and R1234ze is 100 mass % are within the range of a figure surrounded by straight lines US, SF, and FU that connect the following 3 points:

point U (16.1, 37.1, 46.8),
point S (15.9, 51.4, 32.7), and
point F (1.0, 51.5, 47.5),
or on the straight lines US, SF, and FU. When the requirements above are satisfied, the refrigerants according to the present disclosure have a refrigerating capacity ratio of 80% or more relative to that of R410A, and further ensures an ASHRAE lower flammability.

The refrigerant according to the present disclosure comprises HFO-1132(E) in an amount of preferably 1 mass % or more, more preferably 5 mass % or more, and still more preferably 10 mass % or more.

The refrigerant according to the present disclosure comprises R32 in an amount of preferably 1 mass % or more, more preferably 5 mass % or more, and still more preferably 10 mass % or more.

The refrigerant according to the present disclosure comprises R1234ze in an amount of preferably 1 mass % or more, more preferably 5 mass % or more, and still more preferably 10 mass % or more.

The refrigerant according to the present disclosure may further comprise R1234yf.

The refrigerant according to the present disclosure is preferably a refrigerant wherein

when the mass % of HFO-1132(E) is x, the mass % of R32 is y, and the mass % of the sum of R1234ze and R1234yf is z, based on the sum of HFO-1132 (E), R32, R1234ze, and R1234yf in the refrigerant, and when r=R1234yf/(R1234ze+R1234yf), (1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣMᵣ, MᵣNᵣ, NᵣBᵣ″, Bᵣ″Jᵣ, JᵣIᵣ, IᵣHᵣ, HᵣGᵣ, and GᵣKᵣ that connect the following 9 points:

point Kᵣ (72.0, 0.0, 28.0),
point Lᵣ (−0.0618r−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point B″ (0, −0.2268r²+0.2922r+51.422, 0.0083r²−0.1392r+82.165),
point Jᵣ (0, 0.9705r²−13.268r+39.105, −0.9705r²+13.268r+60.895),
point Iᵣ (−13.5r+2.7, 36.5, 13.5r+60.8),
point Hᵣ (−0.4195r²−12.988r+24.311, 0.0618r²+0.0675r+17.988, 0.3577r=+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣIᵣ, IᵣHᵣ, and HᵣGᵣ (excluding point Bᵣ″, point Jᵣ, point Gᵣ, and point Kᵣ),

the line segments LᵣMᵣ, MᵣNᵣ, NᵣBᵣ″, Bᵣ″Jᵣ, JᵣIᵣ, IᵣHᵣ, and GᵣKᵣ are straight lines,

coordinates (x,y,z) of the points on the line segment KᵣLᵣ, are represented by (x, 100-x-z, −0.0114x²+1.1454x+4.503), and

coordinates (x,y,z) of the points on the line segment HᵣGᵣ are represented by (x, 100-x-z, (0.00965r²−0.0024r−0.00319) x²+(−0.6153r²+0.0221r−0.0805) x+(11.593r²+10.251r+61.433)), (2) if 1>r>0.2, coordinates (x,y,z) in the ternary composition diagram are within the range of a figure surrounded by line segments KᵣLᵣ, LᵣMᵣ, MᵣNᵣ, NᵣBᵣ″, Bᵣ″Jᵣ, JᵣHᵣ, HᵣGᵣ, and GᵣKᵣ that connect the following 8 points:

point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r=+0.0675r+51.588, 19.5),
point B″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣHᵣ, and HᵣGᵣ (excluding point Bᵣ″, point Jᵣ, point Gᵣ, and point Kᵣ), and

the line segments LᵣMᵣ, MᵣNᵣ, NᵣBᵣ″, Bᵣ″Jᵣ, JᵣHᵣ, and GᵣKᵣ are straight lines,

wherein

(2-1) if 0.27≥r>0.2,

coordinates (x,y,z) of the points on the line segment KᵣLᵣ are represented by (x, 100-x-z, −0.0114x²+1.1454x+4.503), and coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r²+10.251r+61.433)),

(2-2) if 0.64≥r>0.27,

coordinates (x,y,z) of the points on the line segment KᵣLᵣ are represented by (x, 100-x-z, (0.0003861r²−0.0002973r−0.011348)x+(−0.050193r²+0.038649r+1.1386)x+(1.583r²−1.2189r+4.8167)), and

coordinates (x,y,z) of the points on the line segment HᵣGᵣ are represented by (x, 100-x-z, (0.011147r²−0.010278r−0.00111674)x²+(−0.8771r²+0.6728r−0.2371)x+(12.661r²+0.7382r+63.924)), and

(3) if 1>r>0.64,

coordinates (x,y,z) of the points on the line segment KᵣLᵣ are represented by (x, 100-x-z, −0.01138x²+1.1428x+4.685), and

coordinates (x,y,z) of the points on the line segment HᵣGᵣ are represented by (x, 100-x-z, (0.0003r=−0.0006r−0.0029)x²+(0.0062r²−0.1212r−0.0907)x+(2.1759r²+15.588r+61.137)). When the requirements above are satisfied, the refrigerant according to the present disclosure has a refrigerating capacity ratio of 70% or more relative to that of R410A, and a GWP of 350 or less, and further ensures a WCF lower flammability.

The refrigerant according to the present disclosure is preferably a refrigerant wherein

when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf), coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣHᵣ, HᵣGᵣ, and GᵣKᵣ that connect the following 4 points:

point Kᵣ (72.0, 0.0, 28.0),
point Lᵣ (−0.0618r²−0.0675r+48.612, 0.0618r²+0.0675r+18.088, 33.3),
point Hᵣ (−0.4195r−12.988r+24.311, 0.0618r²+0.0675r+17.988, 0.3577r=+12.9205r+57.701), and
point Gᵣ (−0.1892r²−11.155r+50.918, 0.0, 0.1892r²+11.155r+49.082), or on the line segments KᵣLᵣ, LᵣHᵣ, and HᵣGᵣ (excluding point Gᵣ and point Kᵣ), and

the line segments LᵣHᵣ and GᵣKᵣ are straight lines,

wherein

(2-1) if 0.27≥r>0.2,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, (0.0003861r²−0.0002973r−0.011348)x+(−0.050193r²+0.038649r+1.1386)x+(1.583r²−1.2189r+4.8167)),

(2-2) if 0.64≥r>0.27,

coordinates (x,y,z) of the points on the line segment KᵣLᵣ are represented by (x, 100-x-z, (0.0003861r, −0.0002973r−0.011348)x²+(−0.050193r²+0.038649r+1.1386)x+(1.583r²−1.2189r+4.8167)), and

coordinates (x,y,z) of the points on the line segment HᵣGᵣ are represented by (x, 100-x-z, (0.011147r²−0.010278r−0.00111674)x+(−0.8771r+0.6728r−0.2371)x+(12.661r²+0.7382r+63.924)),

(2-3) if 1>r>0.64,

coordinates (x,y,z) of the points on the line segment KᵣLᵣ are represented by (x, 100-x-z, −0.01138x²+1.1428x+4.685), and

coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)). When the requirements above are satisfied, the refrigerant according to the present disclosure has a refrigerating capacity ratio of 70% or more relative to that of R410A, and a GWP of 125 or less, and further ensures a WCF lower flammability.

The refrigerant according to the present disclosure is preferably a refrigerant wherein

when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf),

(1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments VᵣRᵣ, RᵣSᵣ, SᵣBᵣ″, Bᵣ″Jᵣ, JᵣIᵣ, and IᵣVᵣ that connect the following 6 points:
point Vᵣ (−4.2328r²+14.847r+17.1, 14.815r²−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, −0.491r²−4.6129r+32.703),
point B″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Iᵣ (−13.5r+2.7, 36.5, 13.5r+60.8),
or on the line segments VᵣRᵣ, RᵣSᵣ, SᵣBᵣ″, JᵣIᵣ, and IᵣVᵣ (excluding point Bᵣ″ and point Jᵣ), and

the line segments VᵣRᵣ, RᵣSᵣ, SᵣBᵣ″, Bᵣ″Jᵣ, JᵣIᵣ, and IᵣVᵣ are straight lines,

(2) if 0.27≥r>0.2, coordinates (x,y,z) in the ternary composition diagram are within the range of a figure surrounded by line segments VᵣRᵣ, RᵣSᵣ, SᵣBᵣ″, Bᵣ″Jᵣ, and JᵣVᵣ that connect the following 5 points:
point Vᵣ (−4.2328r²+14.847r+17.1, 14.815r−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r+0.4388r+51.403, 0.491r²−4.6129r+32.703),
point B″ (0, −0.2268r²+0.2922r+51.422, 0.0083r²−0.1392r+82.165), and
point Jᵣ (0, 0.9705r²−13.268r+39.105, −0.9705r²+13.268r+60.895), or on the line segments VᵣRᵣ, RᵣSᵣ, SᵣBᵣ″, and JᵣVᵣ (excluding point Bᵣ″ and point Jᵣ), and

the line segments VᵣRᵣ, RᵣSᵣ, SᵣBᵣ″, Bᵣ″Jᵣ, and JᵣVᵣ are straight lines,

(3) if 0.64≥r>0.27, coordinates (x,y,z) in the ternary composition diagram are within the range of a figure surrounded by line segments VᵣQᵣ, QᵣRᵣ, RᵣSᵣ, SᵣBᵣ″, Bᵣ″Jᵣ, JᵣHᵣ, and HᵣVᵣ that connect the following 7 points:
point Vᵣ (113.4r²−64.271r+29.887, −64.63r²+23.678r+16.318, −48.77r²+40.5931r+53.795),
point Qᵣ (−6.2112r²+15.652r+17.027, 0.7554r²−0.1469r+17.985, 5.4558r²−15.5051r+64.988),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point B″ (0, −0.2268r²+0.2922r+51.422, 0.0083r²−0.1392r+82.165),
point Jᵣ (0, 0.9705r=−13.268r+39.105, −0.9705r²+13.268r+60.895), and
point Hᵣ(−0.4195r²−12.988r+24.311, 0.0618r²+0.0675r+17.988, 0.3577r²+12.9205r+57.701),
or on the line segments VᵣQᵣ, QᵣRᵣ, RᵣSᵣ, SᵣBᵣ″, JᵣHᵣ, and HᵣVᵣ (excluding point Bᵣ″, and point Jᵣ), and

the line segments VᵣRᵣ, QᵣRᵣ, RᵣSᵣ, SᵣBᵣ″, Bᵣ″Jᵣ, JᵣHᵣ, and HᵣVᵣ are straight lines,

(4) if 1.0>r>0.64, coordinates (x,y,z) in the ternary composition diagram are within the range of a figure surrounded by line segments OᵣPᵣ, PᵣQᵣ, QᵣRᵣ, RᵣSᵣ, SᵣBᵣ″, Bᵣ″Jᵣ, JᵣHᵣ, HᵣGᵣ, and GᵣKᵣ that connect the following 9 points:
point Oᵣ (−3.0864r²+15.617r+40.069, 0.0, 3.0864r²−15.617r+59.931),
point Pᵣ (−6.1728r²+21.235r+24.138, 5.0, 6.1728r=−21.235r+70.862),
point Qᵣ (8.8889r+18.811, 18.2, −8.8889r+62.989),
point Rᵣ (−1.3862r²+7.8917r+16.089, 0.0937r=+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point B″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments OᵣPᵣ, PᵣQᵣ, QᵣRᵣ, RᵣSᵣ, SᵣBᵣ″, JᵣHᵣ, and HᵣGᵣ (excluding point Oᵣ, point Bᵣ″, point Jᵣ, and point Gᵣ),

the line segments QᵣRᵣ, RᵣSᵣ, SᵣBᵣ″, Bᵣ″Jᵣ, and JᵣHᵣ are straight lines,

coordinates (x,y,z) of the points on the line segment OᵣPᵣ are represented by (x, 100-x-z, (0.0077r²−0.014r−0.004)x²+(−0.7731r²+1.6132r−0.5209)x+(19.074r²−47.72r+87.771)),

coordinates (x,y,z) of the points on the line segment PᵣQᵣ are represented by (x, 100-x-z, (−0.179r²+0.2997r−0.2085)x²+(11.347r²−17.461r+12.133)x+(−180.86r²+243.12r−107.55)), and

coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r−+15.588r+61.137)). When the requirements above are satisfied, the refrigerant according to the present disclosure has a refrigerating capacity ratio of 70% or more relative to that of R410A, and a GWP of 350 or less, and further ensures an ASHRAE lower flammability.

The refrigerant according to the present disclosure may further comprise other additional refrigerants in addition to HFO-1132 (E), R32, R1234ze, and R1234yf, as long as the above properties and effects are not impaired. In this respect, the refrigerant according to the present disclosure preferably comprises HFO-1132(E), R32, and R1234ze in a total amount of 99.5 mass % or more, more preferably 99.75 mass % or more, and even more preferably 99.9 mass % or more, based on the entire refrigerant. In another embodiment, the refrigerant according to the present disclosure preferably comprises HFO-1132(E), R32, R1234ze, and R1234yf in a total amount of 99.5 mass % or more, more preferably 99.75 mass % or more, and even more preferably 99.9 mass % or more, based on the entire refrigerant.

Such additional refrigerants are not limited, and can be selected from a wide range of refrigerants. The mixed refrigerant may comprise a single additional refrigerant, or two or more additional refrigerants.

### 1.2. Use

The refrigerant according to the present disclosure can be preferably used as a working fluid in a refrigerating machine.

The refrigerant according to the present disclosure is suitable for use as an alternative refrigerant for R410A.

### 2. Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.

The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil. Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### 2.1. Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

### 2.2. Tracer

A tracer is added to the refrigerant composition according to the present disclosure at a detectable concentration such that when the refrigerant composition has been diluted, contaminated, or undergone other changes, the tracer can trace the changes.

The refrigerant composition according to the present disclosure may comprise a single tracer, or two or more tracers.

The tracer is not limited, and can be suitably selected from commonly used tracers.

Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a hydrochlorocarbon, a fluorocarbon, or a fluoroether.

The following compounds are preferable as tracers.

FC-14 (tetrafluoromethane, CF₄)
HCC-40 (chloromethane, CH₃Cl)
HFC-23 (trifluoromethane, CHF₃)
HFC-41 (fluoromethane, CH₃Cl)
HFC-125 (pentafluoroethane, CF₃CHF₂)
HFC-134a (1,1,1,2-tetrafluoroethane, CF₃CH₂F)
HFC-134 (1,1,2,2-tetrafluoroethane, CHF₂CHF₂)
HFC-143a (1,1,1-trifluoroethane, CF₃CH₃)
HFC-143 (1,1,2-trifluoroethane, CHFCH₂F)
HFC-152a (1,1-difluoroethane, CHF₇CH₃)
HFC-152 (1,2-difluoroethane, CH₂FCH₂F)
HFC-161 (fluoroethane, CH₃CH₂F)
HFC-245fa (1,1,1,3, 3-pentafluoropropane, CF₃CH₂CHF₇)
HFC-236fa (1,1,1,3,3, 3-hexafluoropropane, CF₃CH₂CF₃)
HFC-236ea (1,1,1,2,3,3-hexafluoropropane, CF₃CHFCHF₂)
HFC-227ea (1,1,1,2,3,3,3-heptafluoropropane, CF₃CHFCF₃)
HCFC-22 (chlorodifluoromethane, CHClF₂)
HCFC-31 (chlorofluoromethane, CH₂ClF)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether, CF₃OCH₂F)
HFE-143a (trifluoromethyl-methyl ether, CF₃OCH₃)
HFE-227ea (trifluoromethyl-tetrafluoroethyl ether, CF₃OCHFCF₃)
HFE-236fa (trifluoromethyl-trifluoroethyl ether, CF₃OCH₂CF₃)

The refrigerant composition according to the present disclosure may contain one or more tracers at a total concentration of about 10 parts per million by weight (ppm) to about 1000 ppm based on the entire refrigerant composition. The refrigerant composition according to the present disclosure may preferably contain one or more tracers at a total concentration of about 30 ppm to about 500 ppm, and more preferably about 50 ppm to about 300 ppm, based on the entire refrigerant composition.

### 2.3. Ultraviolet Fluorescent Dye

The refrigerant composition according to the present disclosure may comprise a single ultraviolet fluorescent dye, or two or more ultraviolet fluorescent dyes.

The ultraviolet fluorescent dye is not limited, and can be suitably selected from commonly used ultraviolet fluorescent dyes.

Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### 2.4. Stabilizer

The refrigerant composition according to the present disclosure may comprise a single stabilizer, or two or more stabilizers.

The stabilizer is not limited, and can be suitably selected from commonly used stabilizers.

Examples of stabilizers include nitro compounds, ethers, and amines.

Examples of nitro compounds include aliphatic nitro compounds, such as nitromethane and nitroethane; and aromatic nitro compounds, such as nitro benzene and nitro styrene.

Examples of ethers include 1,4-dioxane.

Examples of amines include 2,2,3,3,3-pentafluoropropylamine and diphenylamine.

Examples of stabilizers also include butylhydroxyxylene and benzotriazole.

The content of the stabilizer is not limited. Generally, the content of the stabilizer is preferably 0.01 to 5 mass %, and more preferably 0.05 to 2 mass %, based on the entire refrigerant.

### 2.5. Polymerization Inhibitor

The refrigerant composition according to the present disclosure may comprise a single polymerization inhibitor, or two or more polymerization inhibitors.

The polymerization inhibitor is not limited, and can be suitably selected from commonly used polymerization inhibitors.

Examples of polymerization inhibitors include 4-methoxy-1-naphthol, hydroquinone, hydroquinone methyl ether, dimethyl-t-butylphenol, 2,6-di-tert-butyl-p-cresol, and benzotriazole.

The content of the polymerization inhibitor is not limited. Generally, the content of the polymerization inhibitor is preferably 0.01 to 5 mass %, and more preferably 0.05 to 2 mass %, based on the entire refrigerant.

### 3. Refrigeration Oil-Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### 3.1. Refrigeration Oil

The refrigeration oil-containing working fluid according to the present disclosure may comprise a single refrigeration oil, or two or more refrigeration oils.

The refrigeration oil is not limited, and can be suitably selected from commonly used refrigeration oils. In this case, refrigeration oils that are superior in the action of increasing the miscibility with the mixture and the stability of the mixture, for example, are suitably selected as necessary.

The base oil of the refrigeration oil is preferably, for example, at least one member selected from the group consisting of polyalkylene glycols (PAG), polyol esters (POE), and polyvinyl ethers (PVE).

The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.

A refrigeration oil with a kinematic viscosity of 5 to 400 cSt at 40° C. is preferable from the standpoint of lubrication.

The refrigeration oil-containing working fluid according to the present disclosure may further optionally contain at least one additive. Examples of additives include the compatibilizing agents described below.

### 3.2. Compatibilizing Agent

The refrigeration oil-containing working fluid according to the present disclosure may comprise a single compatibilizing agent, or two or more compatibilizing agents.

The compatibilizing agent is not limited, and can be suitably selected from commonly used compatibilizing agents.

Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### 4. Method for Operating Refrigerating Machine

The method for operating a refrigerating machine according to the present disclosure is a method for operating a refrigerating machine using the refrigerant according to the present disclosure.

Specifically, the method for operating a refrigerating machine according to the present disclosure comprises the step of circulating the refrigerant according to the present disclosure in a refrigerating machine.

The embodiments are described above; however, it will be understood that various changes in forms and details can be made without departing from the spirit and scope of the claims.

Item 1.

A composition comprising a refrigerant, the refrigerant comprising trans-1,2-difluoroethylene (HFO-1132(E)), difluoromethane (R32), and 1,3,3,3-tetrafluoropropene (R1234ze)

Item 2.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NB″, B″J, JI, IH, HG, and GK that connect the following 9 points:

point K (72.0, 0.0, 28.0),
point L (48.6, 18.1, 33.3),
point M (35.7, 36.7, 27.6),
point N (28.9, 51.6, 19.5),
point B″ (0.0, 51.4, 48.6),
point J (0.0, 39.1, 60.9),
point I (2.7, 36.5, 60.8),
point H (24.3, 18.0, 57.7), and
point G (50.9, 0.0, 49.1),
or on the line segments KL, LM, MN, NB″, JI, IH, and HG (excluding point B″, point J, point G, and point K),

the line segments LM, MN, NB″, B″J, JI, IH, and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433).

Item 3.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MI, IH, HG, and GK that connect the following 6 points:

point K (72.0, 0.0, 28.0),
point L (48.6, 18.1, 33.3),
point M (35.7, 36.7, 27.6),
point I (2.7, 36.5, 60.8),
point H (24.3, 18.0, 57.7), and
point G (50.9, 0.0, 49.1),
or on the line segments KL, LM, MI, IH, and HG (excluding point G and point K),

the line segments LM, MI, IH, and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433).

Item 4.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LH, HG, and GK that connect the following 4 points:

point K (72.0, 0.0, 28.0),
point L (48.6, 18.1, 33.3),
point H (24.3, 18.0, 57.7), and
point G (50.9, 0.0, 49.1),
or on the line segments KL, LH, and HG (excluding point G and point K),

the line segments LH and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433).

Item 5.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NF, FE, ED, DC, and CK that connect the following 8 points:

point K (72.0, 0.0, 28.0),
point L (48.6, 18.1, 33.3),
point M (35.7, 36.7, 27.6),
point N (28.9, 51.6, 19.5),
point F (1.0, 51.5, 47.5),
point E (16.7, 36.5, 46.8),
point D (39.8, 18.1, 42.1), and
point C (67.6, 0.0, 32.4),
or on the line segments KL, LM, MN, NF, FE, ED, and DC (excluding point C and point K),

the line segments LM, MN, NF, FE, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

Item 6.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, ME, ED, DC, and CK that connect the following 6 points:

point K (72.0, 0.0, 28.0),
point L (48.6, 18.1, 33.3),
point M (35.7, 36.7, 27.6),
point E (16.7, 36.5, 46.8),
point D (39.8, 18.1, 42.1), and
point C (67.6, 0.0, 32.4),
or on the line segments KL, LM, ME, ED, and DC (excluding point C and point K),

the line segments LM, ME, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

Item 7.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LD, DC, and CK that connect the following 4 points:

point K (72.0, 0.0, 28.0),
point L (48.6, 18.1, 33.3),
point D (39.8, 18.1, 42.1), and
point C (67.6, 0.0, 32.4),
or on the line segments KL, LD, and DC (excluding point C and point K),

the line segments LD and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

Item 8.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by straight lines VR, RS, SB″, B″J, JI, and IV that connect the following 6 points:

point V (17.1, 24.2, 58.7),
point R (16.1, 36.6, 47.3),
point S (15.9, 51.4, 32.7),
point B″ (0.0, 51.4, 48.6),
point J (0.0, 39.1, 60.9), and
point I (2.7, 36.5, 60.8),
or on the straight lines VR, RS, SB″, JI, and IV (excluding point B″ and point J).

Item 9.

The composition according to Item 1, wherein

when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by straight lines US, SF, and FU that connect the following 3 points:

point U (16.1, 37.1, 46.8),
point S (15.9, 51.4, 32.7), and
point F (1.0, 51.5, 47.5),
or on the straight lines US, SF, and FU.

Item 10.

The composition according to Item 1, wherein the refrigerant further comprises R1234yf.

Item 11.

The composition according to Item 10, wherein

when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf), (1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣMᵣ, MᵣNᵣ, NᵣBᵣ″, Bᵣ″Jᵣ, JᵣIᵣ, IᵣHᵣ, HᵣGᵣ, and GᵣKᵣ that connect the following 9 points:

point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Iᵣ (−13.5r+2.7, 36.5, 13.5r+60.8),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣIᵣ, IᵣHᵣ, and HᵣGᵣ (excluding point Bᵣ″, point Jᵣ, point Gᵣ, and point Kᵣ),

the line segments LᵣMᵣ, MᵣNᵣ, NᵣBᵣ″, Bᵣ″Jᵣ, JᵣIᵣ, IᵣHᵣ, and GᵣKᵣ are straight lines,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, (0.00965r²−0.0024r−0.00319)x²+(−0.6153r²+0.0221r−0.0805)x+(11.593r²+10.251r+61.433)), (2) if 1>r>0.2, coordinates (x,y,z) in the ternary composition diagram are within the range of a figure surrounded by line segments KᵣLᵣ, LᵣMᵣ, MᵣNᵣ, NᵣBᵣ″, Bᵣ″Jᵣ, JᵣHᵣ, HᵣGᵣ, and GᵣKᵣ that connect the following 8 points:

point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣHᵣ, and HᵣGᵣ (excluding point Bᵣ″, point Jᵣ, point Gᵣ, and point Kᵣ), and

the line segments LᵣMᵣ, MᵣNᵣ, NᵣBᵣ″, Bᵣ″Jᵣ, JᵣHᵣ, and GᵣKᵣ are straight lines,

wherein

(2-1) if 0.27≥r>0.2,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r²+10.251r+61.433)), and

(2-2) if 0.64≥r>0.27,

coordinates (x,y,z) of the points on the line segment KᵣLᵣ are represented by (x, 100-x-z, (0.0003861r²−0.0002973r−0.011348)x+(−0.050193r²+0.038649r+1.1386)x+(1.583r²−1.2189r+4.8167)), and

coordinates (x,y,z) of the points on the line segment HᵣGᵣ are represented by (x, 100-x-z, (0.011147r=−0.010278r−0.00111674)x²+(−0.8771r²+0.6728r−0.2371)x+(12.661r²+0.7382r+63.924)), and

(3) if 1>r>0.64,

coordinates (x,y,z) of the points on the line segment KᵣLᵣ are represented by (x, 100-x-z, −0.01138x²+1.1428x+4.685), and

coordinates (x,y,z) of the points on the line segment HᵣGᵣ are represented by (x, 100-x-z, (0.0003r²−0.0006r−0.0029)x²+(0.0062r−0.1212r−0.0907)x+(2.1759r²+15.588r+61.137)).

Item 12.

The composition according to Item 10,

wherein

when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf), coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣHᵣ, HᵣGᵣ, and GᵣKᵣ that connect the following 4 points:

point Kᵣ (72.0, 0.0, 28.0),
point Lᵣ (−0.0618r−0.0675r+48.612, 0.0618r²+0.0675r+18.088, 33.3),
point Hᵣ (−0.4195r²−12.988r+24.311, 0.0618r=+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣHᵣ, and HᵣGᵣ (excluding point Gᵣ and point Kᵣ), and

the line segments LᵣHᵣ and GᵣKᵣ are straight lines,

wherein

(2-1) if 0.27≥r>0.2,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r²+10.251r+61.433)),

(2-2) if 0.64≥r>0.27,

coordinates (x,y,z) of the points on the line segment KᵣLᵣ are represented by (x, 100-x-z, (0.0003861r²−0.0002973r−0.011348)x²+(−0.050193r²+0.038649r+1.1386)x+(1.583r²−1.2189r+4.8167)), and

coordinates (x,y,z) of the points on the line segment HᵣGᵣ are represented by (x, 100-x-z, (0.011147r²−0.010278r−0.00111674) x²+(−0.8771r²+0.6728r−0.2371)x+(12.661r²+0.7382r+63.924)), and

(2-3) if 1>r>0.64,

coordinates (x,y,z) of the points on the line segment KᵣLᵣ are represented by (x, 100-x-z, −0.01138x²+1.1428x+4.685), and

coordinates (x,y,z) of the points on the line segment HᵣGᵣ are represented by (x, 100-x-z, (0.0003r²−0.0006r−0.0029) x²+(0.0062r²−0.1212r−0.0907) x+(2.1759r²+15 0.588r+61.137)).

Item 13.

The composition according to Item 10,

wherein

when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf),

(1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments VᵣRᵣ, RᵣSᵣ, SᵣBᵣ″, Bᵣ″Jᵣ, JᵣIᵣ, and IᵣVᵣ that connect the following 6 points:
point Vᵣ (−4.2328r²+14.847r+17.1, 14.815r²−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, −0.491r²−4.6129r+32.703),
point Bᵣ″ (0, −0.2268r²+0.2922r+51.422, 0.0083r=−0.1392r+82.165),
point Jᵣ (0, 0.9705r²−13.268r+39.105, −0.9705r²+13.268r+60.895), and
point Iᵣ (−13.5r+2.7, 36.5, 13.5r+60.8),
or on the line segments VᵣRᵣ, RᵣSᵣ, SᵣBᵣ″, JᵣIᵣ, and IᵣVᵣ (excluding point Bᵣ″ and point Jᵣ), and

the line segments VᵣRᵣ, RᵣSᵣ, SᵣBᵣ″, Bᵣ″Jᵣ, JᵣIᵣ, and IᵣVᵣ are straight lines,

(2) if 0.27≥r>0.2, coordinates (x,y,z) in the ternary composition diagram are within the range of a figure surrounded by line segments VᵣRᵣ, RᵣSᵣ, SᵣBᵣ″, Bᵣ″Jᵣ, and JᵣVᵣ that connect the following 5 points:
point Vᵣ (−4.2328r²+14.847r+17.1, 14.815r²−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r+0.4388r+51.403, 0.491r²−4.6129r+32.703),
point Bᵣ″ (0, −0.2268r²+0.2922r+51.422, 0.0083r²−0.1392r+82.165), and
point Jᵣ (0, 0.9705r²−13.268r+39.105, −0.9705r²+13.268r+60.895), or on the line segments VᵣRᵣ, RᵣSᵣ, SᵣBᵣ″, and JᵣVᵣ (excluding point Bᵣ″ and point Jᵣ), and

the line segments VᵣRᵣ, RᵣSᵣ, SᵣBᵣ″, Bᵣ″Jᵣ, and JᵣVᵣ are straight lines,

(3) if 0.64≥r>0.27, coordinates (x,y,z) in the ternary composition diagram are within the range of a figure surrounded by line segments VᵣQᵣ, QᵣRᵣ, RᵣSᵣ, SᵣBᵣ″, Bᵣ″Jᵣ, JᵣHᵣ, and HᵣVᵣ that connect the following 7 points:
point Vᵣ (113.4r²−64.271r+29.887, −64.63r²+23.678r+16.318, −48.77r²+40.5931r+53.795),
point Qᵣ (−6.2112r²+15.652r+17.027, 0.7554r²−0.1469r+17.985, 5.4558r²−15.5051r+64.988),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Hᵣ (−0.4195r²−12.988r+24.311, 0.0618r²+0.0675r+17.988, 0.3577r²+12.9205r+57.701),
or on the line segments VᵣQᵣ, QᵣRᵣ, RᵣSᵣ, SᵣBᵣ″, JᵣHᵣ, and HᵣVᵣ (excluding point Bᵣ″ and point Jᵣ), and

the line segments VᵣRᵣ, QᵣRᵣ, RᵣSᵣ, SᵣBᵣ″, Bᵣ″Jᵣ, JᵣHᵣ, and HᵣVᵣ are straight lines, and

(4) if 1.0>r>0.64, coordinates (x,y,z) in the ternary composition diagram are within the range of a figure surrounded by line segments OᵣPᵣ, PᵣQᵣ, QᵣRᵣ, RᵣSᵣ, SᵣBᵣ″, Bᵣ″Jᵣ, JᵣHᵣ, HᵣGᵣ, and GᵣKᵣ that connect the following 9 points:
point Oᵣ (−3.0864r²+15.617r+40.069, 0.0, 3.0864r²−15.617r+59.931),
point Pᵣ (−6.1728r²+21.235r+24.138, 5.0, 6.1728r=−21.235r+70.862),
point Qᵣ (8.8889r+18.811, 18.2, −8.8889r+62.989),
point Rᵣ (−1.3862r²+7.8917r+16.089, 0.0937r=+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments OᵣPᵣ, PᵣQᵣ, QᵣRᵣ, RᵣSᵣ, SᵣBᵣ″, JᵣHᵣ, and HᵣGᵣ (excluding point Oᵣ, point Bᵣ″, point Jᵣ, and point Gᵣ),

the line segments QᵣRᵣ, RᵣSᵣ, SᵣBᵣ″, Bᵣ″Jᵣ, and JᵣHᵣ are straight lines,

coordinates (x,y,z) of the points on the line segment OᵣPᵣ are represented by (x, 100-x-z, (0.0077r²−0.014r−0.004)x²+(−0.7731r²+1.6132r−0.5209)x+(19.074r²−47.72r+87.771)),

coordinates (x,y,z) of the points on the line segment PᵣQᵣ are represented by (x, 100-x-z, (−0.179r²+0.2997r−0.2085)x²+(11.347r²−17.461r+12.133)x+(−180.86r²+243.12r−107.55)), and

coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)).

Item 14.

The composition according to any one of Items 1 to 13, for use as a working fluid for a refrigerating machine, wherein the composition further comprises a refrigeration oil.

Item 15.

The composition according to any one of Items 1 to 14, for use as an alternative refrigerant for R410A.

Item 16.

Use of the composition according to any one of Items 1 to 14 as an alternative refrigerant for R410A.

Item 17.

A refrigerating machine comprising the composition according to any one of Items 1 to 14 as a working fluid.

Item 18.

A method for operating a refrigerating machine, comprising the step of circulating the composition according to any one of Items 1 to 14 as a working fluid in a refrigerating machine.

### EXAMPLES

The present disclosure is described in more detail below with reference to Examples. However, the present disclosure is not limited to the Examples.

### Example A

Mixed refrigerants were prepared by mixing HFO-1132(E), R32, R1234ze, and CO₂ at a mass % based on their sum as shown in Tables 1 to 5.

The GWP of R410A (R32=50%/R125=50%) and the mixed refrigerants was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in PTL 1). The refrigerating capacity of R410A and the mixed refrigerants was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.

The COP ratio and the refrigerating capacity ratio of the mixed refrigerants relative to those of R410 were determined. The calculation conditions were as follows.

Evaporating temperature: 5° C.

Condensation temperature: 45° C.

Degree of superheating: 5 K

Degree of subcooling: 5 K

Compressor efficiency: 70%

Table 1 shows these values together with the GWP of each mixed refrigerant. The COP and refrigerating capacity are ratios relative to R410A.

The coefficient of performance (COP) was determined according to the following formula.

COP=(refrigerating capacity or heating capacity)/power consumption

TABLE 1

| | | | Com Ex 2 | Com Ex 3 | Com Ex 4 | Com Ex 5 | Com Ex 6 | Com Ex 7 | Com Ex 8 |
|---|---|---|---|---|---|---|---|---|---|
| Item | Unit | Com Ex 1 | A | B | A′ | B′ | A″ | B″ | C |
| HFO-1132 (E) | mass % | R410A | 81.6 | 06 | 63.1 | 0.0 | 48.2 | 0.0 | 67.6 |
| R32 | mass % | | 18.4 | 17.8 | 36.9 | 36.5 | 51.8 | 51.4 | 0.0 |
| R1234ze | mass % | | 0.0 | 82.2 | 0.0 | 63.5 | 0.0 | 48.6 | 32.4 |
| GWP | — | 2088 | 125 | 125 | 250 | 250 | 350 | 350 | 3 |
| COP ratio | % (relative to R410A) | 100 | 58.7 | 107.8 | 98.7 | 106.2 | 99.2 | 104.6 | 101.4 |
| Refrigerating | % (relative to R410A) | 100 | 106.3 | 52.1 | 109.9 | 68.0 | 112.1 | 79.2 | 80.0 |
| capacity ratio | | | | | | | | | |
| | | Example 1 | Example 2 | Example 3 | Example 4 | Example 5 | Com Ex 9 | Example 6 | Example 7 |
| Item | Unit | C′ | D | E | U | F | G | G′ | H |
| HFO-1132 (E) | mass % | 51.5 | 39.8 | 16.7 | 16.1 | 1.0 | 50.9 | 35.4 | 24.3 |
| R32 | mass % | 10.0 | 18.1 | 36.5 | 37.1 | 51.5 | 0.0 | 10.0 | 18.0 |
| R1234ze | mass % | 38.5 | 42.1 | 46.8 | 46.8 | 47.5 | 49.1 | 54.6 | 57.7 |
| GWP | — | 70 | 125 | 250 | 253 | 350 | 3 | 71 | 125 |
| COP ratio | % (relative to R410A) | 101.8 | 102.3 | 103.5 | 103.6 | 104.5 | 103.2 | 103.9 | 104.6 |
| Refrigerating | % (relative to R410A) | 80.0 | 80.0 | 80.0 | 80.0 | 80.0 | 70.0 | 70.0 | 70.0 |
| capacity ratio | | | | | | | | | |
| | | Example 8 | Example 9 | Com Ex 10 | Com Ex 11 | Example 10 | Example 11 | Example 12 | Example 13 |
| Item | Unit | V | I | J | K | K′ | L | M | N |
| HFO-1132 (E) | mass % | 17.1 | 2.7 | 0.0 | 72.0 | 57.2 | 48.6 | 35.7 | 28.9 |
| R32 | mass % | 24.2 | 36.5 | 39.1 | 0.0 | 10.0 | 18.1 | 36.7 | 51.6 |
| R1234ze | mass % | 58.7 | 60.8 | 60.9 | 28.0 | 32.8 | 33.3 | 27.6 | 19.5 |
| GWP | — | 167 | 250 | 268 | 4 | 70 | 125 | 250 | 350 |
| COP ratio | % (relative to R410A) | 104.9 | 105.7 | 105.9 | 101.1 | 101.2 | 101.2 | 101.0 | 100.9 |
| Refrigerating | % (relative to R410A) | 70.4 | 70.0 | 70.0 | 82.6 | 83.4 | 85.5 | 92.8 | 99.7 |
| capacity ratio | | | | | | | | | |
| | | Com Ex 12 | Com Ex 13 | Com Ex 14 | Com Ex15 | Com Ex 16 | Example 14 | Example 15 | |
| Item | Unit | O | O′ | P | P′ | Q | R | S | |
| HFO-1132 (E) | mass % | 38.4 | 30.3 | 25.4 | 20.4 | 17.6 | 16.1 | 15.9 | |
| R32 | mass % | 0.0 | 2.5 | 5.0 | 10.0 | 17.9 | 36.6 | 51.4 | |
| R1234ze | mass % | 61.6 | 67.2 | 69.6 | 69.6 | 64.5 | 47.3 | 32.7 | |
| GWP | — | 4 | 21 | 38 | 72 | 125 | 250 | 350 | |
| COP ratio | % (relative to R410A) | 104.8 | 105.6 | 106.0 | 106.1 | 105.6 | 103.6 | 102.4 | |
| Refrigerating | % (relative to R410A) | 62.2 | 59.5 | 58.6 | 60.1 | 65.4 | 79.7 | 90.6 | |
| capacity ratio | | | | | | | | | |

The composition of each mixture was defined as WCF. A leak simulation was performed using NIST Standard Reference Data Base Refleak Version 4.0 under the conditions of Equipment, Storage, Shipping, Leak, and Recharge according to the ASHRAE Standard 34-2013. The most flammable fraction was defined as WCFF.

For the flammability, the burning velocity was measured according to the ANSI/ASHRAE Standard 34-2013. Both WCF and WCFF having a burning velocity of 10 cm/s or less were determined to be “Class 2L (lower flammability).”

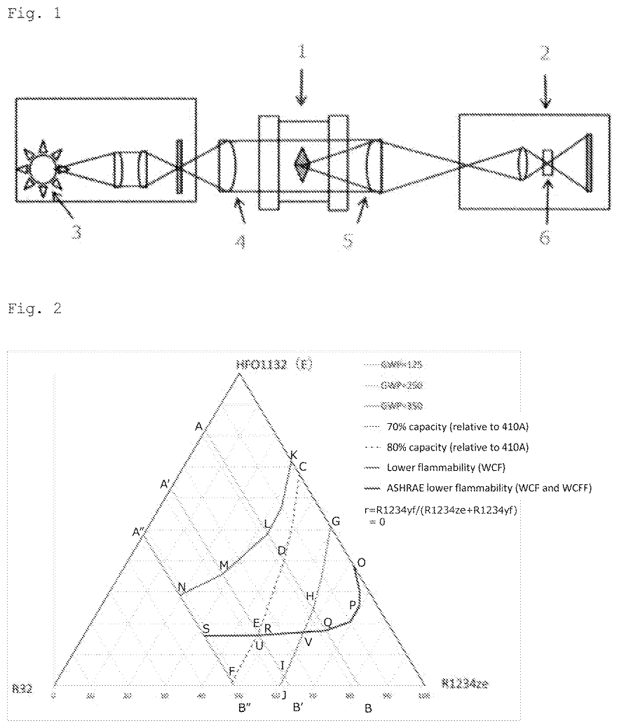

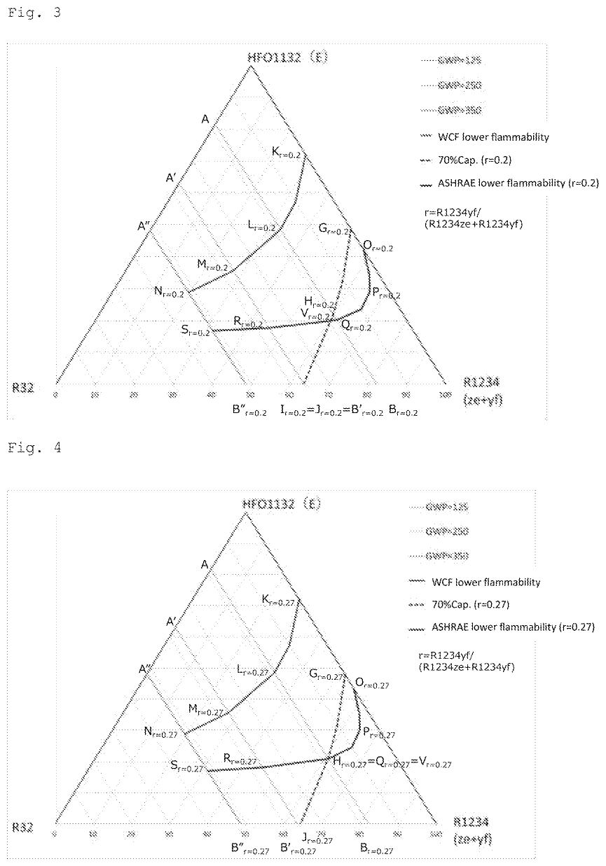

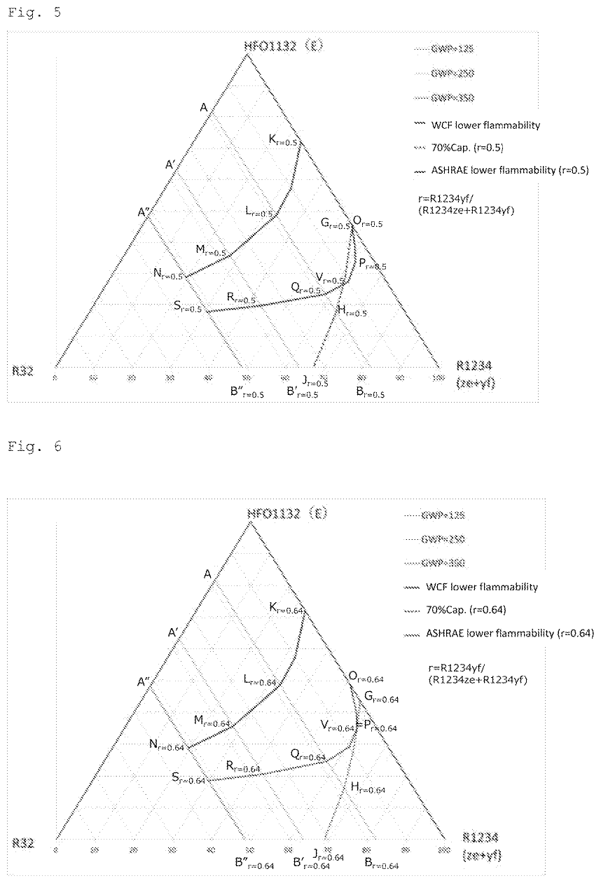

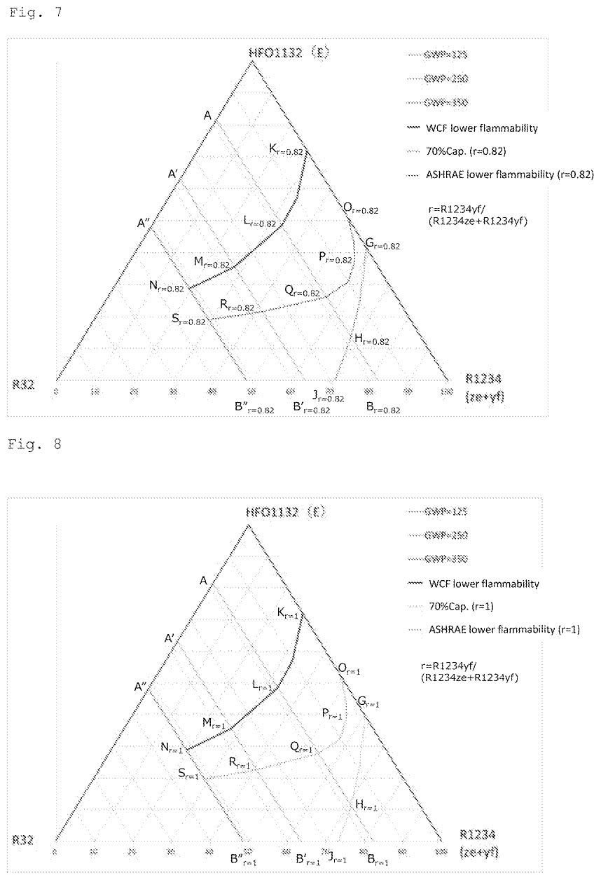

A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. The propagation state of the flame was recorded using a schlieren system with a collimating lens and a high-speed digital video camera (frame rate: 600 fps), and stored on a PC as video data. The flame propagation velocity Sb (cm/sec) was measured using the video image. The burning velocity (Su) is the volume of unburned gas in which the flame surface of the unit area is consumed in the unit time, and was calculated according to the following equation.

Su=Sb*ρu/ρb

ρu: Adiabatic flame temperature (unburned)
ρb: Adiabatic flame temperature (already burned)
ρu was the measured temperature, and ρb was calculated from the heat of the combustion of the combustion gas and the specific heat of constant pressure.

Table 2 shows the results.

TABLE 2

| Item | | Unit | K | K′ | L | M | L |
|---|---|---|---|---|---|---|---|
| WCF | HFO-1132 (E) | mass % | 72.0 | 57.2 | 48.6 | 35.7 | 28.9 |
| | R32 | mass % | 0.0 | 10.0 | 18.1 | 36.7 | 51.6 |
| | R1234ze | mass % | 28.0 | 32.8 | 33.3 | 27.6 | 19.5 |

| | | | | | | |
|---|---|---|---|---|---|---|
| Burning velocity (WCF) | cm/s | 10 | 10 | 10 | 10 | 10 |

| Item | | Unit | O | O′ | P | P′ | Q | R | S |
|---|---|---|---|---|---|---|---|---|---|
| WCF | HFO-1132 (E) | mass % | 38.4 | 30.3 | 25.4 | 20.4 | 17.6 | 16.1 | 15.9 |
| | R32 | mass % | 0.0 | 2.5 | 5.0 | 10.0 | 17.9 | 36.6 | 51.4 |
| | R1234ze | mass % | 61.6 | 67.2 | 69.6 | 69.6 | 64.5 | 47.3 | 32.7 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 34.8° C. | at 34.1° C. | at 33.9° C. | at 34.7° C. | at 36.6° C. | at 39.7° C. | at 40.0° C. |
| | | | and 0% | and 0% | and 0% | and 0% | and 0% | and 0% | and 0% |
| | | | release. | release. | release. | release. | release. | release. | release. |
| | | | gas phase | gas phase | gas phase | gas phase | gas phase | gas phase | gas phase |
| | | | side | side | side | side | side | side | side |
| WCFF | HFO-1132 (E) | mass % | 72.0 | 62.2 | 54.5 | 44.2 | 35.8 | 27.8 | 25.0 |
| | R32 | mass % | 0.0 | 6.1 | 12.3 | 23.4 | 36.4 | 54.4 | 63.2 |
| | R1234ze | mass % | 28.0 | 31.7 | 33.2 | 32.4 | 27.8 | 17.8 | 11.8 |

| | | | | | | | | |
|---|---|---|---|---|---|---|---|---|
| Burning velocity (WCF) | cm/s | 5 or less | 5 or less | 5 or less | 5 or less | 5 or less | 5.2 | 6.5 |
| Burning velocity (WCFF) | cm/s | 10 | 10 | 10 | 10 | 10 | 10 | 10 |

The results indicate that a mixed refrigerant has a refrigerating capacity ratio of 70%- or more relative to that of R410A, and a GWP of 350 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x, y, z) in a ternary composition diagram in which the sum of HFO-1132(E), R32, and R1234ze is 100 mass % are within the range of a figure surrounded by line segments KL, LM, MN, NB″, B″J, JI, IH, HG, and GK that connect the following 9 points:

point K (72.0, 0.0, 28.0),
point L (48.6, 18.1, 33.3),
point M (35.7, 36.7, 27.6),
point N (28.9, 51.6, 19.5),
point B″ (0.0, 51.4, 48.6),
point J (0.0, 39.1, 60.9),
point I (2.7, 36.5, 60.8),
point H (24.3, 18.0, 57.7), and
point G (50.9, 0.0, 49.1),
or on the line segments KL, LM, MN, NB″, JI, IH, and HG (excluding point B″, point J, point G, and point K),

the line segments LM, MN, NB″, B″J, JI, IH, and GK are straight lines,

coordinates (x,y,z) of the points on the line segment KL are represented by (x, 0.0114x−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433),

The results also indicate that a mixed refrigerant has a refrigerating capacity ratio of 70% or more relative to that of R410A, and a GWP of 250 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MI, IH, HG, and GK that connect the following 6 points:

point K (72.0, 0.0, 28.0),
point L (48.6, 18.1, 33.3),
point M (35.7, 36.7, 27.6),
point I (2.7, 36.5, 60.8),
point H (24.3, 18.0, 57.7), and
point G (50.9, 0.0, 49.1),
or on the line segments KL, LM, MI, IH, and HG (excluding point G and point K),

the line segments LM, MI, IH, and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433).

The results also indicate that a mixed refrigerant has a refrigerating capacity ratio of 70% or more relative to that of R410A, and a GWP of 125 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LH, HG, and GK that connect the following 4 points:

point K (72.0, 0.0, 28.0),
point L (48.6, 18.1, 33.3),
point H (24.3, 18.0, 57.7), and
point G (50.9, 0.0, 49.1),
or on the line segments KL, LH, and HG (excluding point G and point K),

the line segments LH and GK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment HG are represented by (x, 0.00319x²−0.9195x+38.567, −0.00319x²−0.0805x+61.433).

The results also indicate that a mixed refrigerant has a refrigerating capacity ratio of 80% or more relative to that of R410A, and a GWP of 350 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NF, FE, ED, DC, and CK that connect the following 8 points:

point K (72.0, 0.0, 28.0),
point L (48.6, 18.1, 33.3),
point M (35.7, 36.7, 27.6),
point N (28.9, 51.6, 19.5),
point F (1.0, 51.5, 47.5),
point E (16.7, 36.5, 46.8),
point D (39.8, 18.1, 42.1), and
point C (67.6, 0.0, 32.4),
or on the line segments KL, LM, MN, NF, FE, ED, and DC (excluding point C and point K),

the line segments LM, MN, NF, FE, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

The results also indicate that a mixed refrigerant has a refrigerating capacity ratio of 80% or more relative to that of R410A, and a GWP of 250 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, ME, ED, DC, and CK that connect the following 6 points:

point K (72.0, 0.0, 28.0),
point L (48.6, 18.1, 33.3),
point M (35.7, 36.7, 27.6),
point E (16.7, 36.5, 46.8),
point D (39.8, 18.1, 42.1), and
point C (67.6, 0.0, 32.4),
or on the line segments KL, LM, ME, ED, and DC (excluding point C and point K),

the line segments LM, ME, ED, and CK are straight lines,

coordinates (x,y,z) of the points on the line segment KL are represented by (x, 0.0114x²−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

The results also indicate that a mixed refrigerant has a refrigerating capacity ratio of 80% or more relative to that of R410A, and a GWP of 125 or less, and further ensures a WCF lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LD, DC, and CK that connect the following 4 points:

point K (72.0, 0.0, 28.0),
point L (48.6, 18.1, 33.3),
point D (39.8, 18.1, 42.1), and
point C (67.6, 0.0, 32.4),
or on the line segments KL, LD, and DC (excluding point C and point K),

the line segments LD and CK are straight lines,

coordinates (x,y,z) of the points on the line segment KL are represented by (x, 0.0114x−2.1454x+95.397, −0.0114x²+1.1454x+4.603), and

coordinates (x,y,z) of the points on the line segment DC are represented by (x, 0.00257x²−0.9261x+50.903, −0.00257x²−0.0739x+49.097).

The results also indicate that a mixed refrigerant has a refrigerating capacity ratio of 70% or more relative to that of R410A, and has ASHRAE lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by straight lines VR, RS, SB″, B″J, JI, and IV that connect the following 6 points:

point V (17.1, 24.2, 58.7),
point R (16.1, 36.6, 47.3),
point S (15.9, 51.4, 32.7),
point B″ (0.0, 51.4, 48.6),
point J (0.0, 39.1, 60.9), and
point I (2.7, 36.5, 60.8),
or on the straight lines VR, RS, SB″, JI, and IV (excluding point B″ and point J).

The results also indicate that a mixed refrigerant has a refrigerating capacity ratio of 80% or more relative to that of R410A, and has ASHRAE lower flammability when the following requirements are satisfied. Specifically, when the mass % of HFO-1132(E), R32, and R1234ze based on their sum in the mixed refrigerant is respectively represented by x, y, and z, coordinates (x,y,z) in a ternary composition diagram in which the sum of HFO-1132(E), R32, and R1234ze is 100 mass % are within the range of a figure surrounded by straight lines US, SF, and FU that connect the following 3 points:

point U (16.1, 37.1, 46.8),
point S (15.9, 51.4, 32.7), and
point F (1.0, 51.5, 47.5),
or on the straight lines US, SF, and FU.

The approximate expressions representing the coordinates of each point were obtained as shown below.

TABLE 3

| Item | Unit | C | C′ | D | G | G′ | H | K | K′ | L |
|---|---|---|---|---|---|---|---|---|---|---|
| HFO-1132 (E) | mass % | 67.6 | 51.5 | 39.8 | 50.9 | 35.4 | 24.3 | 72.0 | 57.2 | 48.6 |
| R32 | mass % | 0.0 | 10.0 | 18.1 | 0.0 | 10.0 | 18.1 | 0.0 | 10.0 | 18.1 |
| R1234ze | mass % | 32.4 | 38.5 | 42.1 | 49.1 | 54.6 | 57.6 | 28.0 | 32.8 | 33.3 |

| x = HFO-1132 (E) | | x | | | x | | | x |
|---|---|---|---|---|---|---|---|---|
| R32 approximate expression | | 0.00257x² − 0.9261x + 50.903 | | | 0.00319x² − 0.9195x + 38.567 | | | 0.0114x² − 2.1454x + 95.397 |
| R1234ze approximate expression | | −0.00257x² − 0.0739x 49.097 | | | −0.0031.9x² − 0.0305x + 61.433 | | | −0.0114x² + 1.1454x + 4.603 |
| Item | Unit | O | O′ | P | P | P′ | Q | |
| HFO-1132 (E) | mass % | 38.4 | 30.3 | 25.4 | 25.4 | 20.4 | 17.6 | |
| R32 | mass % | 0.0 | 2.5 | 5.0 | 5.0 | 10.0 | 17.9 | |
| R1234ze | mass % | 61.6 | 67.2 | 69.6 | 69.6 | 69.6 | 64.5 | |

| | | |
|---|---|---|
| x = HFO-1132 (E) | x | x |
| R32 approximate expression | 0.0155x² − 1.3738x + 29.892 | 0.2335x² − 11.695x + 151.4 |
| R1234ze approximate expression | −0.0155x² + 0.3738x + 70.108 | −0.2335x² + 10.695x² − 51.4 |

### Example B

Mixed refrigerants were prepared so that the mass % of HFO-1132(E), the mass % of R32, the mass % of R1234ze, and the mass % of the sum of R1234ze and R1234yf, based on the sum of HFO-1132(E), R32, R1234ze, and R1234yf were as shown in Tables 4 to 9. Then, evaluation was performed in the same manner as in Example A. Tables 4 to 9 also show the results. r represents R1234yf/(R1234ze+R1234yf).

TABLE 4

| | | | Com Ex 17 | Com Ex 18 | Com Ex 19 | Com Ex 20 | Example 16 | Example 17 | Example 18 |
|---|---|---|---|---|---|---|---|---|---|
| Item | Unit | Com Ex 1 | B_{r=0.2} | B′_{r=0.2} | B″_{r=0.2} | G_{r=0.2} | G′_{r=0.2} | H_{r=0.2} | V_{r=0.2} |
| HFO-1132 (E) | mass % | R410A | 0.0 | 0.0 | 0.0 | 48.7 | 32.9 | 21.8 | 19.9 |
| R32 | mass % | | 17.9 | 36.5 | 51.5 | 0.0 | 10.0 | 18.0 | 19.4 |
| R1234(ze + yf) | mass % | | 82.1 | 63.5 | 48.5 | 51.3 | 57.1 | 60.2 | 60.7 |
| GWP | — | 2088 | 125 | 250 | 350 | 3 | 71 | 125 | 135 |
| COP ratio | % (relative to R410A) | 100 | 107.0 | 105.3 | 104.1 | 102.9 | 103.6 | 104.2 | 104.3 |
| Refrigerating | % (relative to R410A) | 100 | 54.4 | 70.0 | 80.9 | 70.0 | 70.0 | 70.0 | 70.0 |
| capacity ratio | | | | | | | | | |
| | | Com Ex 21 | Com Ex 22 | Example 19 | Example 20 | Example 21 | Example 22 | Com Ex 23 | Com Ex 24 |
| Item | Unit | J_{r=0.2} | K_{r=0.2} | K′_{r=0.2} | L_{r=0.2} | M_{r=0.2} | N_{r=0.2} | O_{r=0.2} | O′_{r=0.2} |
| HFO-1132 (E) | mass % | 0.0 | 72.0 | 57.2 | 48.6 | 35.7 | 28.9 | 42.3 | 34.3 |
| R32 | mass % | 36.5 | 0.0 | 10.0 | 18.1 | 36.7 | 51.6 | 0.0 | 2.5 |
| R1234(ze + yf) | mass % | 63.5 | 28.0 | 32.8 | 33.3 | 27.6 | 19.5 | 57.7 | 63.2 |
| GWP | — | 250 | 2 | 70 | 125 | 250 | 350 | 4 | 21 |
| COP ratio | % (relative to R410A) | 105.3 | 100.9 | 100.8 | 100.8 | 100.7 | 100.8 | 103.6 | 104.3 |
| Refrigerating | % (relative to R410A) | 70.0 | 83.4 | 84.5 | 86.6 | 93.8 | 100.4 | 66.1 | 63.7 |
| capacity ratio | | | | | | | | | |
| | | Com Ex 25 | Com Ex 26 | Com Ex 27 | Example 23 | Example 24 | | | |
| Item | Unit | P_{r=0.2} | P′_{r=0.2} | Q_{r=0.2} | R_{r=0.2} | S_{r=0.2} | | | |
| HFO-1132 (E) | mass % | 29.1 | 23.5 | 20.1 | 17.6 | 16.7 | | | |
| R32 | mass % | 5.0 | 10.0 | 18.0 | 36.6 | 51.5 | | | |
| R1234(ze + yf) | mass % | 65.9 | 66.5 | 61.9 | 45.8 | 31.8 | | | |
| GWP | — | 38 | 71 | 125 | 250 | 350 | | | |
| COP ratio | % (relative to R410A) | 104.7 | 104.8 | 104.4 | 102.8 | 102.0 | | | |
| Refrigerating | % (relative to R410A) | 62.8 | 64.0 | 68.9 | 82.2 | 92.5 | | | |
| capacity ratio | | | | | | | | | |

TABLE 5

| | | | | | | | | Example 26 | |
|---|---|---|---|---|---|---|---|---|---|
| | | | | | | | | H_{r=0.27} | |
| | | | Com Ex 26 | Com Ex 29 | Com Ex 30 | Com Ex 31 | Example 25 | Q_{r=0.27} | Example 27 |
| Item | Unit | Com Ex 1 | B_{r=0.27} | B′_{r=0.27} | B″_{r=0.27} | G_{r=0.27} | G′_{r=0.27} | V_{r=0.27} | J_{r=0.27} |
| HFO-1132 (E) | mass % | R410A | 0.0 | 0.0 | 0.0 | 47.9 | 32.0 | 20.8 | 0.0 |
| R32 | mass % | | 17.9 | 36.5 | 51.5 | 0.0 | 10.0 | 18.0 | 35.7 |
| R1234(ze + yf) | mass % | | 82.1 | 63.5 | 48.5 | 52.1 | 58.0 | 61.2 | 64.3 |
| GWP | — | 2000 | 125 | 250 | 350 | 3 | 71 | 125 | 244 |
| COP ratio | % (relative | 100 | 106.7 | 105.1 | 103.9 | 102.7 | 103.4 | 104.0 | 105.1 |
| | to R410A) | | | | | | | | |
| Refrigerating | % (relative | 100 | 55.2 | 70.6 | 81.5 | 70.0 | 70.0 | 70.0 | 70.0 |
| capacity ratio | to R410A) | | | | | | | | |
| | | Com Ex 32 | Example 28 | Example 29 | Example 30 | Example 31 | Com Ex 33 | Com Ex 34 | Com Ex 35 |
| Item | Unit | K_{r=0.27} | K′_{r=0.27} | L_{r=0.27} | M_{r=0.27} | N_{r=0.27} | O_{r=0.27} | O′_{r=0.27} | P_{r=0.27} |
| HFO-1132 (E) | mass % | 72.0 | 57.2 | 48.6 | 35.7 | 28.9 | 43.5 | 35.5 | 30.2 |
| R32 | mass % | 0.5 | 10.0 | 18.1 | 36.7 | 51.6 | 0.0 | 2.5 | 5.0 |
| R1234(ze + yf) | mass % | 28.0 | 32.8 | 33.3 | 27.6 | 19.5 | 56.5 | 62.0 | 64.8 |
| GWP | — | 2 | 70 | 125 | 250 | 350 | 4 | 21 | 38 |
| COP ratio | % (relative | 100.8 | 100.7 | 100.7 | 100.6 | 100.7 | 103.2 | 103.9 | 104.2 |
| | to R410A) | | | | | | | | |
| Refrigerating | % (relative | 83.7 | 84.8 | 87.0 | 94.1 | 100.7 | 67.4 | 65.0 | 64.1 |
| capacity ratio | to R410A) | | | | | | | | |
| | | Com Ex 36 | Example 32 | Example 33 | | | | | |
| Item | Unit | P′_{r=0.27} | R_{r=0.27} | S_{r=0.27} | | | | | |
| HFO-1132 (E) | mass % | 24.5 | 18.1 | 17.0 | | | | | |
| R32 | mass % | 10.0 | 36.6 | 51.5 | | | | | |
| R1234(ze + yf) | mass % | 65.5 | 45.3 | 31.5 | | | | | |
| GWP | — | 71 | 250 | 350 | | | | | |
| COP ratio | % (relative | 104.4 | 102.6 | 101.9 | | | | | |
| | to R410A) | | | | | | | | |
| Refrigerating | % (relative | 65.2 | 83.1 | 83.1 | | | | | |
| capacity ratio | to R410A) | | | | | | | | |

TABLE 6

| | | | Com Ex 38 | Com Ex 39 | Com Ex 40 | Com Ex 41 | Example 34 | Example 35 | Example 36 |
|---|---|---|---|---|---|---|---|---|---|
| Item | Unit | Com Ex 1 | B_{r=0.5} | B′_{r=0.5} | B″_{r=0.5} | G_{r=0.5} | G″_{r=0.5} | V_{r=0.5} | H_{r=0.5} |
| HFO-1132 (E) | mass % | R410A | 0.0 | 0.0 | 0.0 | 45.3 | 29.0 | 26.1 | 17.7 |
| R32 | mass % | | 17.9 | 36.5 | 51.5 | 0.0 | 10.0 | 12.0 | 18.0 |
| R1234(ze + yf) | mass % | | 82.1 | 63.5 | 48.5 | 54.7 | 61.0 | 61.9 | 64.3 |
| GWP | — | 2088 | 125 | 250 | 350 | 3 | 71 | 84 | 12.5 |
| COP ratio | % (relative to R410A) | 100 | 105.7 | 104.2 | 103.3 | 102.3 | 103.0 | 103.0 | 103.5 |
| Refrigerating | % (relative to R410A) | 100 | 57.6 | 72.8 | 83.4 | 70.0 | 70.0 | 70.0 | 70.0 |
| capacity ratio | | | | | | | | | |
| | | Com Ex 42 | Com Ex 43 | Example 37 | Example 38 | Example 39 | Example 40 | Com Ex 44 | Com Ex 45 |
| Item | Unit | J_{r=0.5} | k_{r=0.5} | K′_{r=0.5} | L_{r=0.5} | M_{r=0.5} | N_{r=0.5} | O_{r=0.5} | O′_{r=0.5} |
| HFO-1132 (E) | mass % | 0.0 | 72.0 | 57.2 | 48.6 | 35.7 | 28.9 | 47.0 | 38.9 |
| R32 | mass % | 32.8 | 0.0 | 10.0 | 18.1 | 36.7 | 51.6 | 0.0 | 2.5 |
| R1234(ze + yf) | mass % | 67.2 | 28.0 | 32.8 | 33.3 | 27.6 | 19.5 | 53.0 | 58.6 |
| GWP | — | 225 | 2 | 70 | 125 | 250 | 350 | 3 | 20 |
| COP ratio | % (relative to R410A) | 104.5 | 100.5 | 100.3 | 100.3 | 100.3 | 100.5 | 102.2 | 102.7 |
| Refrigerating | % (relative to R410A) | 70.0 | 84.5 | 86.0 | 88.2 | 95.3 | 101.5 | 71.0 | 68.8 |
| capacity ratio | | | | | | | | | |
| | | Com Ex 46 | Com Ex 47 | Example 41 | Example 42 | Example 43 | | | |
| Item | Unit | P_{r=0.5} | P′_{r=0.5} | Q_{r=0.2} | R_{r=0.5} | S_{r=0.5} | | | |
| HFO-1132 (E) | mass % | 33.6 | 27.4 | 23.3 | 19.7 | 17.9 | | | |
| R32 | mass % | 5.0 | 10.0 | 18.1 | 36.7 | 51.6 | | | |
| R1234(ze + yf) | mass % | 61.4 | 62.6 | 58.6 | 43.6 | 30.5 | | | |
| GWP | — | 37 | 71 | 125 | 250 | 350 | | | |
| COP ratio | % (relative to R410A) | 103.0 | 103.2 | 102.8 | 101.8 | 101.5 | | | |
| Refrigerating | % (relative to R410A) | 38.0 | 69.0 | 73.6 | 85.8 | 95.0 | | | |
| capacity ratio | | | | | | | | | |

TABLE 7

| | | | Com Ex 48 | Com Ex 49 | Com Ex 50 | Com Ex 51 | Example 44 | Example 45 | Com Ex 52 |
|---|---|---|---|---|---|---|---|---|---|
| Item | Unit | Com Ex 1 | B_{r=0.64} | B′_{r=0.64} | B″_{r=0.64} | G_{r=0.64} | G′_{r=0.64} | H_{r=0.64} | J_{r=0.64} |
| HFO-1132 (E) | mass % | R410A | 0.0 | 0.0 | 0.0 | 43.7 | 27.3 | 15.8 | 0.0 |
| R32 | mass % | | 37.9 | 36.7 | 51.5 | 0.0 | 10.0 | 18.1 | 31.0 |
| R1234(ze + yf) | mass % | | 82.1 | 63.4 | 48.5 | 56.3 | 62.7 | 86.1 | 69.0 |
| GWP | — | 2088 | 125 | 250 | 350 | 3 | 71 | 125 | 213 |
| COP ratio | % (relative | 100 | 305.1 | 103.6 | 103.0 | 102.1 | 102.7 | 103.2 | 104.1 |
| | to R410A) | | | | | | | | |
| Refrigerating | % (relative | 100 | 59.0 | 74.2 | 84.5 | 70.0 | 70.0 | 70.0 | 70.0 |
| capacity ratio | to R410A) | | | | | | | | |
| | | | | | | | | | Example 50 |
| | | Com Ex 53 | Example 46 | Example 47 | Example 48 | Example 49 | Com Ex 54 | Com Ex 55 | P_{r=0.64} |
| Item | Unit | K_{r=0.64} | K′_{r=0.64} | L_{r=0.64} | M_{r=0.64} | N_{r=0.64} | O_{r=0.64} | O′_{r=0.64} | V_{r=0.64} |
| HFO-1132 (E) | mass % | 72.0 | 57.2 | 48.5 | 35.6 | 28.8 | 48.8 | 40.8 | 35.2 |
| R32 | mass % | 0.0 | 10.0 | 15.2 | 36.8 | 51.7 | 0.0 | 2.5 | 5.0 |
| R1234(ze + yf) | mass % | 28.9 | 32.8 | 33.3 | 27.6 | 19.5 | 51.2 | 56.7 | 59.8 |
| GWP | — | 2 | 70 | 125 | 250 | 350 | 3 | 20 | 37 |
| COP ratio | % (relative | 300.3 | 100.3 | 100.0 | 100.1 | 100.4 | 101.7 | 102.1 | 102.3 |
| | to R410A) | | | | | | | | |
| Refrigerating | % (relative | 85.2 | 86.7 | 89.0 | 96.0 | 102.0 | 72.9 | 70.9 | 70.0 |
| capacity ratio | to R410A) | | | | | | | | |
| | | Example 51 | Example 52 | Example 53 | Example 54 | | | | |
| Item | Unit | P′_{r=0.64} | Q_{r=0.64} | R_{r=0.64} | S_{r=0.64} | | | | |
| HFO-1132 (E) | mass % | 29.2 | 24.5 | 20.6 | 18.4 | | | | |
| R32 | mass % | 10.0 | 15.2 | 36.7 | 51.6 | | | | |
| R1234(ze + yf) | mass % | 60.8 | 57.3 | 42.7 | 30.9 | | | | |
| GWP | — | 71 | 126 | 101 | 350 | | | | |
| COP ratio | % (relative | 102.5 | 102.2 | 87.4 | 101.2 | | | | |
| | to R410A) | | | | | | | | |
| Refrigerating | % (relative | 71.2 | 75.0 | 87.5 | 96.1 | | | | |
| capacity ratio | to R410A) | | | | | | | | |

TABLE 8

| | | | Com Ex 56 | Com Ex 57 | Com Ex 58 | Com Ex 59 | Example 55 | Example 56 | Com Ex 60 |
|---|---|---|---|---|---|---|---|---|---|
| Item | Unit | Com Ex 1 | B_{r=0.82} | B′_{r=0.82} | B″_{r=0.82} | G_{r=0.82} | G″_{r=0.82} | H_{r=0.82} | J_{r=0.82} |
| HFO-1132 (E) | mass % | R410A | 0.0 | 0.0 | 0.0 | 41.6 | 25.0 | 13.4 | 0.0 |
| R32 | mass % | | 17.9 | 36.6 | 51.5 | 0.0 | 10.0 | 18.1 | 28.8 |
| R1234(ze + yf) | mass % | | 82.1 | 63.4 | 48.5 | 58.4 | 65.0 | 68.5 | 71.2 |
| GWP | — | 2088 | 125 | 250 | 350 | 3 | 171 | 125 | 198 |
| COP ratio | % (relative | 100 | 103.3 | 103.0 | 102.0 | 101.7 | 102.3 | 102.8 | 103.5 |
| | to R410A) | | | | | | | | |
| Refrigerating | % (relative | 100 | 60.7 | 75.9 | 86.0 | 70.0 | 70.0 | 70.0 | 70.0 |
| capacity ratio | to R410A) | | | | | | | | |
| | | Com Ex 61 | Example 57 | Example 58 | Example 59 | Example 60 | Com Ex 62 | Example 61 | Example 62 |
| Item | Unit | K_{r=0.82} | K′_{r=0.82} | L_{r=0.82} | M_{r=0.82} | N_{r=0.82} | O_{r=0.82} | O′_{r=0.82} | P_{r=0.82} |
| HFO-1132 (E) | mass % | 72.0 | 57.2 | 48.5 | 35.6 | 28.5 | 50.8 | 42.9 | 37.4 |
| R32 | mass % | 0.0 | 10.0 | 18.2 | 36.8 | 51.7 | 0.0 | 2.5 | 5.0 |
| R1234(ze + yf) | mass % | 28.0 | 32.8 | 33.3 | 27.6 | 19.5 | 49.2 | 64.6 | 57.6 |
| GWP | — | 2 | 70 | 125 | 250 | 350 | 3 | 20 | 9 |
| COP ratio | % (relative | 100.1 | 99.8 | 99.7 | 99.9 | 100.3 | 101.1 | 101.4 | 101.6 |
| | to R410A) | | | | | | | | |
| Refrigerating | % (relative | 85.9 | 87.5 | 89.9 | 96.8 | 102.6 | 75.1 | 73.3 | 72.6 |
| capacity ratio | to R410A) | | | | | | | | |
| | | Example 63 | Example 64 | Example 65 | Example 66 | | | | |
| Item | Unit | P′_{r=0.82} | Q_{r=0.82} | R_{r=0.82} | S_{r=0.82} | | | | |
| HFO-1132 (E) | mass % | 30.9 | 26.1 | 21.6 | 19.1 | | | | |
| R32 | mass % | 10.0 | 18.2 | 36.8 | 51.7 | | | | |
| R1234(ze + yf) | mass % | 59.1 | 55.7 | 41.6 | 29.2 | | | | |
| GWP | — | 70 | 126 | 250 | 350 | | | | |
| COP ratio | % (relative | 101.7 | 101.4 | 100.9 | 100 9 | | | | |
| | to R410A) | | | | | | | | |
| Refrigerating | % (relative | 73.5 | 77.8 | 89.3 | 97.4 | | | | |
| capacity ratio | to R410A) | | | | | | | | |

TABLE 9

| | | | Com Ex 62 | Com Ex 63 | Com Ex 64 | Com Ex 65 | Com Ex 66 | Com Ex 67 | Com Ex 68 |
|---|---|---|---|---|---|---|---|---|---|
| Item | Unit | Com Ex 1 | Bᵣ₌₁ | B′ᵣ₌₁ | B″ᵣ₌₁ | Gᵣ₌₁ | G′ᵣ₌₁ | Hᵣ₌₁ | Jᵣ₌₁ |
| HFO-1132 (E) | mass % | R410A | 0.0 | 0.0 | 0.0 | 39.6 | 22.8 | 10.9 | 0.0 |
| R32 | mass % | | 18.0 | 36.6 | 51.5 | 0.0 | 10.0 | 18.1 | 26.8 |
| R1234 (ze + yf) | mass % | | 82.0 | 69.4 | 48.5 | 60.4 | 67.2 | 71.0 | 73.2 |
| GWP | | 2088 | 125 | 250 | 350 | 3 | 70 | 125 | 184 |
| COP ratio | % (relative | 100 | 103.6 | 102.3 | 102.2 | 101.4 | 101.8 | 102.4 | 102.9 |
| | to R410A) | | | | | | | | |
| Refrigerating | % (relative | 100 | 62.4 | 77.4 | 87.3 | 70.0 | 70.0 | 70.0 | 70.0 |
| capacity ratio | to R410A) | | | | | | | | |
| | | Com Ex 69 | Com Ex 70 | Com Ex 71 | Com Ex 72 | Com Ex 73 | Com Ex 74 | Com Ex 75 | Com Ex 76 |
| Item | Unit | Kᵣ₌₁ | K′ᵣ₌₁ | Lᵣ₌₁ | Mᵣ₌₁ | Nᵣ₌₁ | Oᵣ₌₁ | O′ᵣ₌₁ | Pᵣ₌₁ |
| HFO-1132 (E) | mass % | 72.0 | 57.2 | 43.5 | 35.6 | 28.8 | 52.6 | 44.7 | 39.2 |
| R32 | mass % | 0.0 | 10.0 | 18.2 | 36.8 | 51.7 | 0.0 | 2.0 | 5.0 |
| R1234 (ze + yf) | mass % | 28.0 | 32.8 | 33.3 | 27.6 | 19.5 | 47.4 | 52.8 | 55.8 |
| GWP | | 2 | 69 | 125 | 250 | 350 | 2 | 19 | 36 |
| COP ratio | % (relative | 99.9 | 99.5 | 99.4 | 99.6 | 100.1 | 100.5 | 100.7 | 100.9 |
| | to R410A) | | | | | | | | |
| Refrigerating | % (relative | 86.6 | 88.4 | 90.8 | 97.7 | 103.2 | 77.1 | 75.3 | 74.8 |
| capacity ratio | to R410A) | | | | | | | | |
| | | Com Ex 77 | Com Ex 78 | Com Ex 79 | Com Ex 80 | | | | |
| Item | Unit | P′ᵣ₌₁ | Qᵣ₌₁ | Rᵣ₌₁ | Sᵣ₌₁ | | | | |
| HFO-1132 (E) | mass % | 32.4 | 27.7 | 22.6 | 19.7 | | | | |
| R32 | mass % | 10.0 | 18.2 | 38.5 | 51.7 | | | | |
| R1234 (ze + yf) | mass % | 57.6 | 54.1 | 40.6 | 28.6 | | | | |
| GWP | | 70 | 125 | 250 | 350 | | | | |
| COP ratio | % (relative | 100.9 | 100.7 | 100.4 | 100.7 | | | | |
| | to R410A) | | | | | | | | |
| Refrigerating | % (relative | 75.6 | 80.0 | 91.0 | 98.7 | | | | |
| capacity ratio | to R410A) | | | | | | | | |

These mixed refrigerants were subjected to the burning velocity test in the same manner as in Example A. Tables 10 to 15 show the results.

TABLE 10

| Item | | Unit | K_{r=0.2} | K′_{r=0.2} | L_{r=0.2} | M_{r=0.2} | L_{r=0.2} | | |
|---|---|---|---|---|---|---|---|---|---|
| WCF | HFO-1132 (E) | mass % | 72.0 | 57.2 | 48.6 | 36.7 | 28.9 | | |
| | R32 | mass % | 0.0 | 10.0 | 18.1 | 36.7 | 51.6 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | O_{r=0.2} | O′_{r=0.2} | P_{r=0.2} | P′_{r=0.2} | Q_{r=0.2} | R_{r=0.2} | S_{r=0.2} |
| WCF | HFO-1132 (E) | mass % | 42.3 | 34.3 | 29.1 | 23.5 | 20.1 | 17.6 | 16.7 |
| | R32 | mass % | 0.0 | 2.5 | 5.0 | 10.0 | 18.0 | 36.6 | 51.5 |
| | R1234 (ze + yf) | mass % | 57.7 | 63.2 | 65.9 | 66.5 | 61.9 | 45.8 | 31.8 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 36.1° C. | at 35.6° C. | at 35.6° C. | at 36.2° C. | at 37.7° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 62.8 | 55.6 | 45.6 | 37.2 | 28.7 | 25.4 |
| | R32 | mass % | 0.0 | 5.7 | 11.3 | 21.6 | 34.0 | 51.9 | 61.5 |
| | R1234ze | mass % | 19.6 | 22.0 | 23.0 | 22.7 | 19.8 | 13.3 | 9.0 |
| | R1234yf | mass % | 8.4 | 9.5 | 10.1 | 10.1 | 9.0 | 6.1 | 4.1 |

| | | | | | | | | |
|---|---|---|---|---|---|---|---|---|
| Burning velocity (WCF) | cm/s | 5 or less | 5 or less | 5 or less | 5 or less | 5 or less | 6.4 | 6.7 |
| Burning velocity (WCFF) | cm/s | 10 | 10 | 10 | 10 | 10 | 10 | 10 |

TABLE 11

| Item | | Unit | K_{r=0.27} | K′_{r=0.27} | L_{r=0.27} | M_{r=0.27} | L_{r=0.27} | | |
|---|---|---|---|---|---|---|---|---|---|
| WCF | HFO-1132 (E) | mass % | 72.0 | 57.2 | 48.6 | 35.7 | 28.9 | | |
| | R32 | mass % | 0.0 | 10.0 | 18.1 | 36.7 | 51.6 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | O_{r=0.27} | O′_{r=0.27} | P_{r=0.27} | P′_{r=0.27} | Q_{r=0.27} | R_{r=0.27} | S_{r=0.27} |
| WCF | HFO-1132 (E) | mass % | 43.5 | 35.5 | 30.2 | 24.5 | 20.8 | 18.1 | 17.0 |
| | R32 | mass % | 0.0 | 2.5 | 5.0 | 10.0 | 18.0 | 36.6 | 51.5 |
| | R1234 (ze + yf) | mass % | 56.5 | 62.0 | 64.8 | 65.5 | 61.2 | 45.3 | 31.5 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 36.5° C. | at 36.1° C. | at 36.0° C. | at 36.6° C. | at −38° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 63.0 | 55.8 | 46.0 | 37.5 | 29.0 | 25.6 |
| | R32 | mass % | 0.0 | 5.6 | 11.1 | 21.1 | 33.3 | 51.2 | 60.9 |
| | R1234ze | mass % | 17.1 | 19.2 | 20.2 | 19.9 | 17.6 | 11.9 | 8.1 |
| | R1234yf | mass % | 10.9 | 12.2 | 12.9 | 13.0 | 11.6 | 7.9 | 5.4 |

| | | | | | | | | |
|---|---|---|---|---|---|---|---|---|
| Burning velocity (WCF) | cm/s | 5 or less | 5 or less | 5 or less | 5 or less | 5 or less | 5.6 | 6.8 |
| Burning velocity (WCFF) | cm/s | 10 | 10 | 10 | 10 | 10 | 10 | 10 |

TABLE 12

| Item | | Unit | K_{r=0.5} | K′_{r=0.5} | L_{r=0.5} | M_{r=0.5} | L_{r=0.5} | | |
|---|---|---|---|---|---|---|---|---|---|
| WCF | HFO-1132 (E) | mass % | 72.0 | 57.2 | 48.5 | 35.6 | 28.8 | | |
| | R32 | mass % | 0.0 | 10.0 | 18.2 | 36.8 | 51.7 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | O_{r=0.5} | O′_{r=0.5} | P_{r=0.5} | P′_{r=0.5} | Q_{r=0.5} | R_{r=0.5} | S_{r=0.5} |
| WCF | HFO-1132 (E) | mass % | 47.0 | 38.9 | 33.6 | 27.4 | 23.3 | 19.7 | 17.9 |
| | R32 | mass % | 0.0 | 2.5 | 5.0 | 10.0 | 18.1 | 36.7 | 51.6 |
| | R1234 (ze + yf) | mass % | 53.0 | 58.6 | 61.4 | 62.6 | 58.6 | 43.6 | 30.5 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 37.6° C. | at 37.3° C. | at 37.3° C. | at 37.3° C. | at 39.0° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 63.4 | 56.6 | 47.1 | 38.7 | 29.9 | 26.1 |
| | R32 | mass % | 0.0 | 5.2 | 10.4 | 19.8 | 31.5 | 49.0 | 59.3 |
| | R1234ze | mass % | 10.5 | 11.7 | 12.3 | 12.2 | 10.9 | 7.6 | 5.3 |
| | R1234yf | mass % | 17.5 | 19.7 | 20.7 | 20.9 | 18.9 | 13.5 | 9.3 |

| | | | | | | | | |
|---|---|---|---|---|---|---|---|---|
| Burning velocity (WCF) | cm/s | 5 or less | 5 or less | 5 or less | 5 or less | 5 or less | 6.0 | 7.0 |
| Burning velocity (WCFF) | cm/s | 10 | 10 | 10 | 10 | 10 | 10 | 10 |

TABLE 13

| Item | | Unit | K_{r=0.64} | K′_{r=0.64} | L_{r=0.64} | M_{r=0.64} | L_{r=0.64} | | |
|---|---|---|---|---|---|---|---|---|---|
| WCF | HFO-1132 (E) | mass % | 72.0 | 57.2 | 48.5 | 35.6 | 28.8 | | |
| | R32 | mass % | 0.0 | 10.0 | 18.2 | 36.8 | 51.7 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | O_{r=0.64} | O′_{r=0.64} | P_{r=0.64} | P′_{r=0.64} | Q_{r=0.64} | R_{r=0.64} | S_{r=0.64} |
| WCF | HFO-1132 (E) | mass % | 48.8 | 40.8 | 35.2 | 29.1 | 24.5 | 20.6 | 18.4 |
| | R32 | mass % | 0.0 | 2.5 | 5.0 | 10.0 | 18.2 | 36.7 | 51.6 |
| | R1234 (ze + yf) | mass % | 51.2 | 56.7 | 59.8 | 60.9 | 57.3 | 42.7 | 30.0 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 38.2° C. | at 38.0° C. | at 37.9° C. | at 38.5° C. | at 39.5° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 63.7 | 56.9 | 47.7 | 39.1 | 30.4 | 26.4 |
| | R32 | mass % | 0.0 | 5.1 | 10.1 | 19.2 | 30.7 | 47.9 | 58.4 |
| | R1234ze | mass % | 7.1 | 7.9 | 8.3 | 8.3 | 7.5 | 5.3 | 3.7 |
| | R1234yf | mass % | 20.9 | 23.3 | 24.7 | 24.8 | 22.7 | 16.4 | 11.5 |

| | | | | | | | | |
|---|---|---|---|---|---|---|---|---|
| Burning velocity (WCF) | cm/s | 5 or less | 5 or less | 5 or less | 5 or less | 5 or less | 6.2 | 7.1 |
| Burning velocity (WCFF) | cm/s | 10 | 10 | 10 | 10 | 10 | 10 | 10 |

TABLE 14

| Item | | Unit | K_{r=0.82} | K′_{r=0.82} | L_{r=0.82} | M_{r=0.82} | L_{r=0.82} | | |
|---|---|---|---|---|---|---|---|---|---|
| WCF | HFO-1132 (E) | mass % | 72.0 | 57.2 | 48.5 | 35.6 | 28.8 | | |
| | R32 | mass % | 0.0 | 10.0 | 18.2 | 36.8 | 51.7 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | O_{r=0.82} | O′_{r=0.82} | P_{r=0.82} | P′_{r=0.82} | Q_{r=0.82} | R_{r=0.82} | S_{r=0.82} |
| WCF | HFO-1132 (E) | mass % | 50.8 | 42.9 | 37.4 | 30.9 | 26.1 | 21.6 | 19.1 |
| | R32 | mass % | 0.0 | 2.5 | 5.0 | 10.0 | 18.2 | 36.8 | 51.7 |
| | R1234 (ze + yf) | mass % | 49.2 | 54.6 | 57.6 | 59.1 | 55.7 | 41.6 | 29.2 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 38.8° C. | at 38.7° C. | at 38.7° C. | at 39.2° C. | at 40.0° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 63.9 | 57.4 | 48.3 | 39.8 | 30.9 | 26.8 |
| | R32 | mass % | 0.0 | 4.9 | 9.8 | 18.5 | 29.6 | 46.7 | 57.4 |
| | R1234ze | mass % | 3.3 | 3.7 | 3.9 | 3.9 | 3.6 | 2.6 | 1.8 |
| | R1234yf | mass % | 24.7 | 27.5 | 28.9 | 29.3 | 27.0 | 19.8 | 14.0 |

| | | | | | | | | |
|---|---|---|---|---|---|---|---|---|
| Burning velocity (WCF) | cm/s | 5 or less | 5 or less | 5 or less | 5 or less | 5 or less | 6.4 | 7.3 |
| Burning velocity (WCFF) | cm/s | 10 | 10 | 10 | 10 | 10 | 10 | 10 |

TABLE 15

| Item | | Unit | Kᵣ₌₁ | K′ᵣ₌₁ | Lᵣ₌₁ | Mᵣ₌₁ | Lᵣ₌₁ | | |
|---|---|---|---|---|---|---|---|---|---|
| WCF | HFO-1132 (E) | mass % | 72.0 | 57.2 | 48.5 | 35.6 | 28.8 | | |
| | R32 | mass % | 0.0 | 10.0 | 18.2 | 36.8 | 51.7 | | |
| | R1234 (ze + yf) | mass % | 28.0 | 32.8 | 33.3 | 27.6 | 19.5 | | |
| Burning velocity (WCF) | | cm/s | 10 | 10 | 10 | 10 | 10 | | |
| Item | | Unit | Oᵣ₌₁ | O′ᵣ₌₁ | Pᵣ₌₁ | P′ᵣ₌₁ | Qᵣ₌₁ | Rᵣ₌₁ | Sᵣ₌₁ |
| WCF | HFO-1132 (E) | mass % | 52.6 | 44.7 | 39.2 | 32.4 | 27.7 | 22.6 | 19.7 |
| | R32 | mass % | 0.0 | 2.5 | 5.0 | 10.0 | 18.2 | 36.8 | 51.7 |
| | R1234 (ze + yf) | mass % | 47.4 | 52.8 | 55.8 | 57.6 | 54.1 | 40.6 | 28.6 |
| Leak conditions for achieving WCFF | | | Storage | Storage | Storage | Storage | Storage | Storage | Storage |
| | | | and | and | and | and | and | and | and |
| | | | transport | transport | transport | transport | transport | transport | transport |
| | | | at 39.4° C. | at 39.3° C. | at 39.4° C. | at 39.8° C. | at 40.0° C. | at 40.0° C. | at 40.0° C. |
| | | | and 0% | and 0% | and 0% | and 0% | and 0% | and 0% | and 0% |
| | | | release, | release, | release, | release, | release, | release, | release, |
| | | | gas phase | gas phase | gas phase | gas phase | gas phase | gas phase | gas phase |
| | | | side | side | side | side | side | side | side |
| WCFF | HFO-1132 (E) | mass % | 72.0 | 64.1 | 57.8 | 48.7 | 40.6 | 31.4 | 27.1 |
| | R32 | mass % | 0.0 | 4.8 | 9.5 | 17.9 | 28.7 | 45.7 | 56.4 |
| | R1234ze | mass % | 0.0 | 0.0 | 0.0 | 0.0 | 0.0 | 0.0 | 0.0 |
| | R1234yf | mass % | 28.0 | 31.1 | 32.7 | 33.4 | 30.7 | 22.9 | 16.5 |

| | | | | | | | | |
|---|---|---|---|---|---|---|---|---|
| Burning velocity (WCF) | cm/s | 5 or less | 5 or less | 5 or less | 5 or less | 5.1 | 6.6 | 7.5 |
| Burning velocity (WCFF) | cm/s | 10 | 10 | 10 | 10 | 10 | 10 | 10 |

The results indicate that a mixed refrigerant has a refrigerating capacity ratio of 70% or more relative to that of R410A, and a GWP of 350 or less, and further ensures a WCF lower flammability when the following requirements are satisfied. Specifically, when the mass % of HFO-1132(E) is x, the mass % of R32 is y, and the mass % of the sum of R1234ze and R1234yf is z, based on the sum of HFO-1132(E), R32, R1234ze, and R1234yf in the mixed refrigerant, and when r=R1234yf/(R1234ze+R1234yf), (1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣMᵣ, MᵣNᵣ, NᵣBᵣ″, Bᵣ″Jᵣ, JᵣIᵣ, IᵣHᵣ, HᵣGᵣ, and GᵣKᵣ, that connect the following 9 points:

point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point B″ (0, −0.2268r²+0.2922r+51.422, 0.0083r²−0.1392r+82.165),
point Jᵣ (0, 0.9705r²−13.268r+39.105, −0.9705r²+13.268r+60.895),
point Iᵣ (−13.5r+2.7, 36.5, 13.5r+60.8),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣIᵣ, IᵣHᵣ, and HᵣGᵣ (excluding point Bᵣ″, point Jᵣ, point Gᵣ, and point Kᵣ),

the line segments LᵣMᵣ, MᵣNᵣ, NᵣBᵣ″, Bᵣ″Jᵣ, JᵣIᵣ, IᵣHᵣ, and GᵣKᵣ are straight lines,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, (0.00965r²−0.0024r−0.00319) x²+(−0.6153r²+0.0221r−0.0805) x+(11.593r²+10.251r+61.433)), (2) if 1>r>0.2, coordinates (x,y,z) in the ternary composition diagram are within the range of a figure surrounded by line segments KᵣLᵣ, LᵣMᵣ, MᵣNᵣ, NᵣBᵣ″, Bᵣ″Jᵣ, JᵣHᵣ, HᵣGᵣ, and GᵣKᵣ that connect the following 8 points:

point Kᵣ (72.0, 0.0, 28.0),
point Lᵣ (−0.0618r²−0.0675r+48.612, 0.0618r=+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point B″ (0, −0.2268r+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣMᵣ, MᵣNᵣ, NᵣBᵣ″, JᵣHᵣ, and HᵣGᵣ (excluding point Bᵣ″, point Jᵣ, point Gᵣ, and point Kᵣ), and

the line segments LᵣMᵣ, MᵣNᵣ, NᵣBᵣ″, Bᵣ″Jᵣ, JᵣHᵣ, and GᵣKᵣ are straight lines, wherein

(2-1) if 0.27≥r>0.2,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r+10.251r+61.433)) and

(2-2) if 0.64≥r>0.27,

coordinates (x,y,z) of the points on the line segment KᵣLᵣ are represented by (x, 100-x-z, (0.0003861r²−0.0002973r−0.011348)x+(−0.050193r²+0.038649r+1.1386)x+(1.583r²−1.2189r+4.8167)), and

coordinates (x,y,z) of the points on the line segment HᵣGᵣ are represented by (x, 100-x-z, (0.011147r²−0.010278r−0.00111674)x²+(−0.8771r²+0.6728r−0.2371)x+(12.661r²+0.7382r+63.924)), and

(3) if 1>r>0.64,

coordinates (x,y,z) of the points on the line segment KᵣLᵣ are represented by (x, 100-x-z, −0.01138x²+1428x+4.685), and

coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137))

The results also indicate that a mixed refrigerant has a refrigerating capacity ratio of 70% or more relative to that of R410A, and a GWP of 125 or less, and further ensures a WCF lower flammability when the following requirements are satisfied. Specifically, when the mass % of HFO-1132(E) is x, the mass % of R32 is y, and the mass % of the sum of R1234ze and R1234yf is z, based on the sum of HFO-1132(E), R32, R1234ze, and R1234yf in the mixed refrigerant, and when r=R1234yf/(R1234ze+R1234yf), coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣHᵣ, HᵣGᵣ, and GᵣKᵣ that connect the following 4 points:

point Kᵣ (72.0, 0.0, 28.0),
point Lᵣ (−0.0618r−0.0675r+48.612, 0.0618r+0.0675r+18.088, 33.3),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments KᵣLᵣ, LᵣHᵣ, and HᵣGᵣ (excluding point Gᵣ and point Kᵣ), and

the line segments LᵣHᵣ and GᵣKᵣ are straight lines, wherein

(2-1) if 0.27≥r>0.2,

coordinates (x,y,z) of the points on the line segment KᵣLᵣ are represented by (x, 100-x-z, −0.0114x²+1.1454x+4.503), and

coordinates (x,y,z) of the points on the line segment HᵣGᵣ are represented by coordinates (x,y,z) of the points on the line segment

(x, 100-x-z, (0.0003861r²−0.0002973r−0.011348)x²+(−0.050193r²+0.038649r+1.1386)x+(1.583r²−1.2189r+4.8167)),

(2-2) if 0.64≥r>0.27,

coordinates (x,y,z) of the points on the line segment KᵣLᵣ are represented by (x, 100-x-z, (0.0003861r²−0.0002973r−0.011348) x²+(−0.050193r²+0.038649r+1.1386) x+(1.583r²−1.2189r+4.8167)), and

coordinates (x,y,z) of the points on the line segment HᵣGᵣ are represented by (x, 100-x-z, (0.011147r²−0.010278r−0.00111674)x²+(−0.8771r+0.6728r−0.2371)x+(12.661r²+0.7382r+63.924)), and

(2-3) if 1>r>0.64,

coordinates (x,y,z) of the points on the line segment KᵣLᵣ are represented by (x, 100-x-z, −0.01138x²+1.1428x+4.685), and

coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)).

The results also indicate that a mixed refrigerant has a refrigerating capacity ratio of 70% or more relative to that of R410A, and a GWP of 350 or less, and further has an ASHRAE lower flammability when the following requirements are satisfied. Specifically, when the mass % of HFO-1132(E) is x, the mass % of R32 is y, and the mass % of the sum of R1234ze and R1234yf is z, based on the sum of HFO-1132(E), R32, R1234ze, and R1234yf in the mixed refrigerant, and when r=R1234yf/(R1234ze-+R1234yf),

(1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments VᵣRᵣ, RᵣSᵣ, SᵣBᵣ″, Bᵣ″Jᵣ, JᵣIᵣ, and IᵣVᵣ, that connect the following 6 points:
point Vᵣ (−4.2328r²+14.847r+17.1, 14.815r−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, −0.491r²−4.6129r+32.703),
point B″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Iᵣ (−13.5r+2.7, 36.5, 13.5r+60.8),
or on the line segments VᵣRᵣ, RᵣSᵣ, SᵣBᵣ″, JᵣIᵣ, and IᵣVᵣ (excluding point Bᵣ″ and point Jᵣ), and

the line segments VᵣRᵣ, RᵣSᵣ, SᵣBᵣ″, Bᵣ″Jᵣ, JᵣIᵣ, and IᵣVᵣ are straight lines,

(2) if 0.27≥r>0.2, coordinates (x,y,z) in the ternary composition diagram are within the range of a figure surrounded by line segments VᵣRᵣ, RᵣSᵣ, SᵣBᵣ″, Bᵣ″Jᵣ, and JᵣVᵣ that connect the following 5 points:
point Vᵣ (−4.2328r²+14.847r+17.1, 14.815r=−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r−+4.1741r+15.894, −0.1332r²+0.4388r+51.403, 0.491r²−4.6129r+32.703),
point B″ (0, −0.2268r²+0.2922r+51.422, 0.0083r²−0.1392r+82.165), and
point Jᵣ (0, 0.9705r²−13.268r+39.105, −0.9705r²+13.268r+60.895), or on the line segments VᵣRᵣ, RᵣSᵣ, SᵣBᵣ″, and JᵣVᵣ (excluding point Bᵣ″ and point Jᵣ), and

the line segments VᵣRᵣ, RᵣSᵣ, SᵣBᵣ″, Bᵣ″Jᵣ, and JᵣVᵣ are straight lines,

(3) if 0.64≥r>0.27, coordinates (x,y,z) in the ternary composition diagram are within the range of a figure surrounded by line segments VᵣQᵣ, QᵣRᵣ, RᵣSᵣ, SᵣBᵣ″, Bᵣ″Jᵣ, JᵣHᵣ, and HᵣVᵣ that connect the following 7 points:
point Vᵣ (113.4r²−64.271r+29.887, −64.63r²+23.678r+16.318, −48.77r²+40.5931r+53.795),
point Qᵣ (−6.2112r²+15.652r+17.027, 0.7554r²−0.1469r+17.985, 5.4558r²−15.5051r+64.988),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point B″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Hᵣ (−0.4195r²−12.988r+24.311, 0.0618r²+0.0675r+17.988, 0.3577r²+12.9205r+57.701),
or on the line segments VᵣQᵣ, QᵣRᵣ, RᵣSᵣ, SᵣBᵣ″, JᵣHᵣ, and HᵣVᵣ (excluding point Bᵣ″ and point Jᵣ), and

the line segments VᵣRᵣ, QᵣRᵣ, RᵣSᵣ, SᵣBᵣ″, Bᵣ″Jᵣ, JᵣHᵣ, and HᵣVᵣ are straight lines,

(4) if 1.0>r>0.64, coordinates (x,y,z) in the ternary composition diagram are within the range of a figure surrounded by line segments coordinates (x,y,z) in the ternary composition diagram are within the range of a figure surrounded by line segments OᵣPᵣ, PᵣQᵣ, QᵣRᵣ, RᵣSᵣ, SᵣBᵣ″, Bᵣ″Jᵣ, JᵣHᵣ, HᵣGᵣ, and GᵣKᵣ that connect the following 9 points:
point Oᵣ (−3.0864r²+15.617r+40.069, 0.0, 3.0864r²−15.617r+59.931),
point Pᵣ (−6.1728r²+21.235r+24.138, 5.0, 6.1728r²−21.235r+70.862),
point Qᵣ (8.8889r+18.811, 18.2, −8.8889r+62.989),
point Rᵣ (−1.3862r²+7.8917r+16.089, 0.0937r=+0.1466r+36.581, 1.2925r=−8.0383r+47.33),
point Sᵣ (−0.3578r²+4.1741r+15.894, −0.1332r²+0.4388r+51.403, 0.491r²−4.6129r+32.703),
point B″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082), or on the line segments OᵣPᵣ, PᵣQᵣ, QᵣRᵣ, RᵣSᵣ, SᵣBᵣ″, JᵣHᵣ, and HᵣGᵣ (excluding point Oᵣ, point Bᵣ″, point Jᵣ, and point Gᵣ),

the line segments QᵣRᵣ, RᵣSᵣ, SᵣBᵣ″, Bᵣ″Jᵣ, and JᵣHᵣ are straight lines,

coordinates (x,y,z) of the points on the line segment OᵣPᵣ are represented by (x, 100-x-z, (0.0077r²−0.014r−0.004)x²+(−0.7731r=+1.6132r−0.5209)x+(19.074r²−47.72r+87.771)),

coordinates (x,y,z) of the points on the line segment PᵣQᵣ are represented by (x, 100-x-z, (−0.179r²+0.2997r−0.2085)x²+(11.347r²−17.461r+12.133)x+(−180.86r²+243.12r−107.55)), and coordinates (x,y,z) of the points on the line segment HᵣGᵣ are represented by (x, 100-x-z, (0.0003r²−0.0006 r−0.0029)x²+(0.0062r²−0.1212r−0.0907)x+(2.1759r²+15.588r+61.137)).

The coordinates of each point were obtained using approximate expressions as shown below.

TABLE 16
Point B

| | | Point Br (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.32 | 1.00 |
| HFO-1132 (E) | mass % | 0.0 | 0.0 | 0.0 | 0.0 | 0.0 | 0.0 | 0.0 |
| R32 | mass % | 17.8 | 17.9 | 17.9 | 17.9 | 17.9 | 17.9 | 18.0 |
| R1234 (ze + yf) | mass % | 82.2 | 82.1 | 82.1 | 82.1 | 82.1 | 82.1 | 82.0 |

| | |
|---|---|
| x = HFO-1132(E) approximate expression | 0.0 |
| y = R32 approximate expression | −0.0083r² + 0.1392r + 17.835 |
| z = R1234(ze + yf) approximate expression | 0.0083r² − 0.1392r + 82.165 |

Point B′

| | | Point B′r (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 0.0 | 0.0 | 0.0 | 0.0 | 0.0 | 0.0 | 0.0 |
| R32 | mass % | 36.5 | 36.5 | 36.5 | 36.5 | 36.6 | 36.6 | 36.6 |
| R1234 (ze + yf) | mass % | 63.5 | 63.5 | 63.5 | 63.5 | 63.4 | 63.4 | 63.4 |

| | |
|---|---|
| x = HFO-1132(E) approximate expression | 0.0 |
| y = R32 approximate expression | 0.0618r² + 0.0675r + 36.488 |
| z = R1234(ze + yf) approximate expression | 0.0083r² − 0.1392r + 82.165 |

Point B″

| | | Point B″r (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 0.0 | 0.0 | 0.0 | 0.0 | 0.0 | 0.0 | 0.0 |
| R32 | mass % | 51.4 | 51.5 | 51.5 | 51.5 | 51.5 | 51.5 | 51.5 |
| R1234 (ze + yf) | mass % | 48.6 | 48.5 | 48.5 | 48.5 | 48.5 | 48.5 | 48.5 |

| | |
|---|---|
| x = HFO-1132(E) approximate expression | 0.0 |
| y = R32 approximate expression | −0.2268r² + 0.2922r + 51.422 |
| z = R1234(ze + yf) approximate expression | 0.0083r² − 0.1392r + 82.165 |

Point G

| | | Point Gr (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 50.9 | 48.7 | 47.9 | 45.3 | 43.7 | 41.6 | 39.6 |
| R32 | mass % | 0.0 | 0.0 | 0.0 | 0.0 | 0.0 | 0.0 | 0.0 |
| R1234 (ze + yf) | mass % | 49.1 | 51.3 | 52.1 | 54.7 | 56.3 | 58.4 | 60.4 |

| | |
|---|---|
| x = HFO-1132(E) approximate expression | −0.1392r² − 11.155r + 50.918 |
| y = R32 approximate expression | 0.0 |
| z = R1234(ze + yf) approximate expression | 0.1892r² + 11.155r + 49.082 |

Point H

| | | Point Hr (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 24.3 | 21.7 | 20.8 | 17.7 | 15.8 | 13.4 | 10.9 |
| R32 | mass % | 18.0 | 18.0 | 18.0 | 18.0 | 18.1 | 18.1 | 18.1 |
| R1234 (ze + yf) | mass % | 57.7 | 60.2 | 61.2 | 64.3 | 66.1 | 68.5 | 71.0 |

| | |
|---|---|
| x = HFO-1132(E) approximate expression | −0.4195r² − 12.988r + 24.311 |
| y = R32 approximate expression | 0.0618r² + 0.0675r + 17.988 |
| z = R1234(ze + yf) approximate expression | 0.3577r² + 12.9205r + 57.701 |

Point J

| | | Point Jr (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 0.0 | 0.0 | 0.0 | 0.0 | 0.0 | 0.0 | 0.0 |
| R32 | mass % | 39.1 | 36.5 | 35.6 | 32.7 | 31.0 | 28.9 | 26.3 |
| R1234 (ze + yf) | mass % | 60.9 | 63.5 | 64.4 | 67.3 | 69.0 | 71.1 | 73.2 |
| x = HFO-1132(E) approximate expression | | 0.0 | | | | | | |
| y = R32 approximate expression | | 0.9705r² − 13.268r + 39.105 | | | | | | |
| z = R1234(ze + yf) approximate expression | | −0.9705r² + 13.268r + 60.895 | | | | | | |
| Item | Unit | K | K_{r=0.2} | K_{r=0.27} | K_{r=0.5} | K_{r=0.64} | K_{r=0.82} | Kᵣ₌₁ |
| HFO-1132 (E) | mass % | 72.0 | 72.0 | 72.0 | 72.0 | 72.0 | 72.0 | 72.0 |
| R32 | mass % | 0.0 | 0.0 | 0.0 | 0.0 | 0.0 | 0.0 | 0.0 |
| R1234 (ze + yf) | mass % | 28.0 | 28.0 | 28.0 | 28.0 | 28.0 | 28.0 | 28.0 |
| Item | Unit | K′ | K′_{r=0.2} | K′_{r=0.27} | K′_{r=0.5} | K′_{r=0.64} | K′_{r=0.82} | K′ᵣ₌₁ |
| HFO-1132 (E) | mass % | 57.2 | 57.2 | 57.2 | 57.2 | 57.2 | 57.2 | 57.2 |
| R32 | mass % | 10.0 | 10.0 | 10.0 | 10.0 | 10.0 | 10.0 | 10.0 |
| R1234 (ze + yf) | mass % | 32.8 | 32.8 | 32.8 | 32.8 | 32.8 | 32.8 | 32.8 |

Point L

| | | Point Lr (r = R1234yf/(R1234ze + R12434yf)) | | | | | | |
|---|---|---|---|---|---|---|---|---|
| Item | Unit | 0 | 0.2 | 0.27 | 0.5 | 0.64 | 0.82 | 1 |
| HFO-1132 (E) | mass % | 48.6 | 48.6 | 48.6 | 48.6 | 48.5 | 48.5 | 48.5 |
| R32 | mass % | 18.1 | 18.1 | 18.1 | 18.1 | 18.2 | 18.2 | 18.2 |
| R1234 (ze + yf) | mass % | 33.3 | 33.3 | 33.3 | 33.3 | 33.3 | 33.3 | 33.3 |

| | |
|---|---|
| x = HFO-1132(E) approximate expression | −0.0618r² − 0.0675r + 48.612 |
| y = R32 approximate expression | 0.0618r² + 0.0675r + 18.088 |
| z = R1234(ze + yf) approximate expression | 33.3 |

TABLE 18
Point M

| | | Point Mr (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 35.7 | 35.7 | 35.7 | 35.7 | 35.6 | 35.6 | 35.6 |
| R32 | mass % | 36.7 | 36.7 | 36.7 | 36.7 | 36.8 | 36.8 | 36.8 |
| R1234 (ze + yf) | mass % | 27.6 | 27.6 | 27.6 | 27.6 | 27.6 | 27.6 | 27.6 |

| | |
|---|---|
| x = HFO-1132 (E) approxmate expression | −0.0618r² − 0.0675r + 35.712 |
| y = R32 approximate expression | 0.06130 + 0.0675r + 36.683 |
| z = R1234(ze + yf) approximate expression | 27.6 |

Point N

| | | Point Nr (r = R1234yf/(R1234ze + R12434yf)) | | | | | | |
|---|---|---|---|---|---|---|---|---|
| Item | Unit | 0.00 | 0.20 | 0.27 | 0.50 | 0.64 | 0.82 | 1.00 |
| HFO-1132 (E) | mass % | 28.9 | 28.9 | 28.9 | 28.9 | 28.8 | 28.8 | 28.8 |
| R32 | mass % | 51.6 | 51.6 | 51.6 | 51.6 | 51.7 | 51.7 | 51.7 |
| R1234 (ze + yf) | mass % | 19.5 | 19.5 | 19.5 | 19.5 | 19.5 | 19.5 | 19.5 |

| | |
|---|---|
| x = HFO-1132 (E) approxmate expression | −0.0618r² − 0.0675r + 28.912 |
| y = R32 approximate expression | 0.0618r² + 0.0675r + 51.588 |
| z = R1234(ze + yf) approximate expression | 19.5 |

Point O

| | | Point Or (r = R1234yf/(R1234ze + R12434yf)) | | | | | | | | |
|---|---|---|---|---|---|---|---|---|---|---|
| Item | Unit | 0.00 | 0.20 | 0.27 | 0.27 | 0.50 | 0.64 | 0.64 | 0.82 | 1.00 |
| HFO-1132 (E) | mass % | 38.4 | 42.3 | 43.5 | 43.5 | 47.0 | 48.6 | 48.8 | 50.8 | 52.6 |
| R32 | mass % | 0.0 | 0.0 | 0.0 | 0.0 | 0.0 | 0.0 | 0.0 | 0.0 | 0.0 |
| R1234 (ze + yf) | mass % | 61.6 | 57.7 | 56.5 | 56.5 | 53.0 | 51.2 | 51.2 | 49.2 | 47.4 |

| | | | |
|---|---|---|---|
| x = HFO-1132 (E) approxmate expression | −8.7302r² + 21.246r + 38.4 | −6.379r² + 20.129 + 38.53 | −3.0864r² + 15.617r + 40.069 |
| y = R32 approximate expression | 0.0 | 0.0 | 0.0 |
| z = R1234(ze + yf) approximate expression | 8.7302r² − 21.246r + 61.6 | 6.379r² − 20.129r + 61.47 | 3.0864r² − 15.617r + 59.931 |

Point P

| | | Point Pr (r = R1234yf/(R1234ze + R12434yf)) | | | | | | | | |
|---|---|---|---|---|---|---|---|---|---|---|
| Item | Unit | 0 | 0.2 | 0.27 | 0.27 | 0.5 | 0.64 | 0.64 | 0.82 | 1 |
| HFO-1132 (E) | mass % | 25.4 | 29.1 | 30.2 | 30.2 | 33.6 | 35.2 | 35.2 | 37.4 | 39.2 |
| R32 | mass % | 5.0 | 5.0 | 5.0 | 5.0 | 5.0 | 5.0 | 5.0 | 5.0 | 5.0 |
| R1234 (ze + yf) | mass % | 69.6 | 65.9 | 64.8 | 64.8 | 61.4 | 59.8 | 59.8 | 57.6 | 55.8 |

| | | | |
|---|---|---|---|
| x = HFO-1132 (E) approxmate expression | −10.317r² + 20.563r + 25.4 | −9.065r² + 21.763r + 24.985 | −6.1728r² + 21.235r + 24.138 |
| y = R32 approximate expression | 5.0 | 5.0 | 5.0 |
| z = R1234(ze + yf) approximate expression | 10.317r² − 20.563r + 69.6 | 9.065r² − 21.763r + 70.015 | 6.1728r² − 21.235r + 70.362 |

TABLE 19
Point Q

| | | Point Qr (r = R1234yf/(R1234ze + R1234yf)) | | | | | | | | |
|---|---|---|---|---|---|---|---|---|---|---|
| Item | Unit | 0 | 0.2 | 0.27 | 0.27 | 0.5 | 0.64 | 0.64 | 0.82 | 1 |
| HFO-1132 (E) | mass % | 17.6 | 20.1 | 20.8 | 20.8 | 23.3 | 24.5 | 24.5 | 26.1 | 27.7 |
| R32 | mass % | 17.9 | 13.0 | 18.0 | 18.0 | 18.1 | 18.2 | 18.2 | 18.2 | 18.2 |
| R1234 (ze + yf) | mass % | 64.5 | 61.9 | 61.2 | 61.2 | 58.6 | 57.3 | 57.3 | 55.7 | 54.1 |

| | | | |
|---|---|---|---|
| x = HFO-1132 (E) approximate expression | −9.2593r² + 14.352r + 17.6 | −6.2112r² + 15.652r + 17.027 | 8.8889r + 18.811 |
| y = R32 approximate expression | −1.8519r² + 0.8704r + 17.9 | 0.7554r² − 0.1469r + 17.985 | 18.2 |
| z = R1234(ze + yf) approximate expression | 11.1112r² − 15.2224r + 64.5 | 5.4558r² − 15.5051r + 56.988 | −8.8889r + 62.989 |

Point R

| | | Point Pr (r = R1234yf/(R1234ze + R1234yf)) | | | | | | |
|---|---|---|---|---|---|---|---|---|
| Item | Unit | 0 | 0.2 | 0.27 | 0.5 | 0.64 | 0.82 | 1 |
| HFO-1132 (E) | mass % | 16.1 | 17.6 | 18.1 | 19.7 | 20.6 | 21.6 | 22.6 |
| R32 | mass % | 36.6 | 36.6 | 36.6 | 36.7 | 36.7 | 36.8 | 36.8 |
| R1234 (ze + yf) | mass % | 47.3 | 45.8 | 45.3 | 43.6 | 42.7 | 41.6 | 40.6 |

| | |
|---|---|
| x = HFO-1132 (E) approximate expression | −1.3362r² + 7.8917r + 16.089 |
| y = R32 approximate expression | 0.0937r² + 0.1466r + 36.581 |
| z = R1234(ze + yf) approximate expression | 1.2925r² − 8.0383r + 47.33 |

Point S

| | | Point Sr (r = R1234yf/(R1234ze + R1234yf)) | | | | | | |
|---|---|---|---|---|---|---|---|---|
| Item | Unit | 0 | 0.2 | 0.27 | 0.5 | 0.64 | 0.82 | 1 |
| HFO-1132 (E) | mass % | 15.9 | 16.7 | 17.0 | 17.9 | 18.4 | 19.1 | 19.7 |
| R32 | mass % | 51.1 | 51.5 | 51.5 | 51.6 | 51.6 | 51.7 | 51.7 |
| R1234 (ze + yf) | mass % | 32.7 | 31.8 | 31.5 | 30.5 | 30.0 | 29.2 | 28.6 |

| | |
|---|---|
| x = HFO-1132 (E) approximate expression | −0.3578r² + 4.1711r + 15.894 |
| y = R32 approximate expression | −0.1332r² + 0.4388r + 51.403 |
| z = R1234(ze + yf) approximate expression | 0.491r² − 4.6129r + 32.703 |

Point I

| | | Point Ir | |
|---|---|---|---|
| Item | Unit | 0 | 0.2 |
| HFO-1132 (E) | mass % | 2.7 | 0.0 |
| R32 | mass % | 36.5 | 36.5 |
| R1234 (ze + yf) | mass % | 60.8 | 63.5 |

| | |
|---|---|
| x = HFO-1132 (E) approximate expression | −13.5r + 2.7 |
| y = R32 approximate expression | 36.5 |
| z = R1234(ze + yf) approximate expression | 13.5r + 60.8 |

TABLE 20
Point V

| | | Point Vr (r = R1234yf/(R1234ze + R12434yf)) | | | | | |
|---|---|---|---|---|---|---|---|
| Item | Unit | 0 | 0.2 | 0.27 | 0.27 | 0.5 | 0.64 |
| HFO-1132 (E) | mass % | 17.1 | 19.9 | 20.8 | 20.8 | 26.1 | 35.2 |
| R32 | mass % | 24.2 | 19.4 | 18.0 | 18.0 | 12.0 | 5.0 |
| R1234 (ze + yf) | mass % | 58.7 | 60.7 | 61.2 | 61.2 | 61.9 | 59.8 |

| | | |
|---|---|---|
| x = HFO-1132 (E) approximate expression | −4.2328r² + 14.847r + 17.1 | 113.4r² − 64.271r + 29.887 |
| y = R32 approximate expression | 14.815r² − 26.963r + 24.2 | −64.63r² + 23.678r + 16.318 |
| z = R1234(ze + yf) approximate expression | =D245 | −48.77r² + 40.5931r + 53.795 |

The coordinates of the points on each line segment were obtained using the approximate expressions as shown below.

TABLE 21
Line segment GrHr

| Item | Unit | r | Gᵣ | G′ᵣ | Hᵣ | r | Gᵣ | G′ᵣ | Hᵣ | r | Gᵣ | G′ᵣ | Hᵣ |
|---|---|---|---|---|---|---|---|---|---|---|---|---|---|
| HFO-1332 (E) | mass % | 0 | 50.9 | 35.4 | 24.3 | 0.27 | 47.9 | 32.0 | 20.8 | 0.64 | 43.7 | 27.3 | 15.7 |
| R32 | mass % | | 0.0 | 10.0 | 13.1 | | 0.0 | 10.0 | 18.0 | | 0.0 | 10.0 | 18.1 |
| R1234(ze + yf)) | mass % | | 49.1 | 54.6 | 57.6 | | 52.1 | 58.0 | 61.2 | | 56.3 | 62.7 | 66.2 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.00319x2 −0.0805x + | | | | −0.00313x² − 0.1194x + | | | | −0.00318x² − 0.1658x + 69.582 | | |
| approximate | | | 61.433 | | | | 65.046 | | | | | | |
| HFO-1332 (E) | mass % | 0.2 | 48.7 | 32.9 | 21.8 | 0.5 | 45.2 | 29.0 | 17.8 | 0.82 | 41.6 | 25.0 | 13.3 |
| R32 | mass % | | 0.0 | 10.0 | 18.0 | | 0.0 | 10.0 | 18.0 | | 0.0 | 10.0 | 18.1 |
| R1234(ze + yf)) | mass % | | 51.3 | 57.1 | 60.2 | | 54.8 | 61.0 | 64.2 | | 58.4 | 65.0 | 68.6 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.00328x² − 0.1007x + | | | | −0.00352x² − 0.12x + | | | | −0.0032x² − 0.186x + 71.636 | | |
| approximate | | | 63.947 | | | | 67.453 | | | | | | |
| HFO-1332 (E) | mass % | 0.27 | 47.9 | 32.0 | 20.8 | 0.64 | 43.7 | 27.3 | 15.7 | 1 | 39.6 | 22.8 | 11.0 |
| R32 | mass % | | 0.0 | 10.0 | 18.0 | | 0.0 | 10.0 | 13.1 | | 0.0 | 10.0 | 13.1 |
| R1234(ze + yf)) | mass % | | 52.1 | 58.0 | 61.2 | | 56.3 | 62.7 | 66.2 | | 60.4 | 67.2 | 70.9 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.00313x² − 0.1194x + | | | | −0.00318x² − 0.1658x + | | | | −0.0032x² − 0.2058x + 73.549 | | |
| approximate | | | 65.046 | | | | 69.532 | | | | | | |
| | | r | a | b | c | r | a | b | c | r | a | b | c |

| | | | | | | | | | | | | |
|---|---|---|---|---|---|---|---|---|---|---|---|---|
| R1234(ze + yf) | 0 | −0.00319 | −0.0805 | 61.433 | 0.27 | −0.00313 | −0.1194 | 65.046 | 0.64 | −0.00318 | −0.1658 | 69.582 |
| approximate expression | 0.2 | −0.00328 | −0.1007 | 63.947 | 0.5 | −0.00352 | −0.12 | 67.453 | 0.82 | −0.0032 | −0.186 | 71.636 |
| when x = HFO-1132(E) | 0.27 | −0.00313 | −0.1194 | 65.046 | 0.64 | −0.00318 | −0.1658 | 69.582 | 1 | −0.0032 | −0.2058 | 73.549 |

| | | | |
|---|---|---|---|
| and r = yf/(rf + ze) | (0.00965r² − 0.0024r − 0.00319)x² + | (0.011147r² − 0.010278r − | (0.0003r² − 0.0006r − 0.0029)x² + |
| | (−0.6153r² + 0.0221r − 0.0805)x + | 0.00111674)x² + | (0.0062r² − 0.1212r − 0.0907)x + |
| | (11.593r² + 10.251r + 61.433) | (−0.8771r² + 0.6728r − 0.2371)x+ | (2.1759r² + 15.588r + 61.137) |

TABLE 22
Line segment KrLr

| Item | Unit | r | Kᵣ | K′ᵣ | Lᵣ | r | Kᵣ | K′ᵣ | Lᵣ | r | Kᵣ | K′ᵣ | Lᵣ |
|---|---|---|---|---|---|---|---|---|---|---|---|---|---|
| HFO-1132 (E) | mass % | 0 | 72.0 | 57.2 | 48.6 | 0.27 | 72.0 | 57.2 | 48.6 | 0.64 | 72.0 | 57.2 | 48.5 |
| R32 | mass % | | 0.0 | 10.0 | 18.1 | | 0.0 | 10.0 | 18.1 | | 0.0 | 10.0 | 18.2 |
| R1234(ze + yf)) | mass % | | 28.0 | 32.8 | 33.3 | | 28.0 | 32.8 | 33.3 | | 28.0 | 32.8 | 33.3 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.0114x² + 1.145x + 4.503 | | | | −0.0114x² + 1.145x + 4.603 | | | | −0.03138x² + 1.1428x + 4.685 | | |
| approximate | | | | | | | | | | | | | |
| HFO-1332 (E) | mass % | 0.2 | 72.0 | 57.2 | 48.6 | 0.5 | 72.0 | 57.2 | 48.6 | 0.82 | 72.0 | 57.2 | 48.5 |
| R32 | mass % | | 0.0 | 10.0 | 18.1 | | 0.0 | 10.0 | 18.1 | | 0.0 | 10.0 | 18.2 |
| R1234(ze + yf)) | mass % | | 28.0 | 32.8 | 33.3 | | 28.0 | 32.8 | 33.3 | | 28.0 | 32.8 | 33.3 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.0114x² + 1.145x + 4.603 | | | | −0.0114x² + 1.145x + 4.603 | | | | −0.011138x² + 1.1428x + 4.685 | | |
| approximate | | | | | | | | | | | | | |
| HFO-1332 (E) | mass % | 0.27 | 72.0 | 57.2 | 48.6 | 0.64 | 72.0 | 57.2 | 48.5 | 1 | 72.0 | 57.2 | 48.5 |
| R32 | mass % | | 0.0 | 10.0 | 38.1 | | 0.0 | 10.0 | 18.2 | | 0.0 | 10.0 | 15.2 |
| R1234(ze + yf)) | mass % | | 28.0 | 32.8 | 33.3 | | 28.0 | 32.8 | 33.3 | | 28.0 | 32.8 | 33.3 |
| x = HFO-1132(E) | | | x | | | | x | | | | x | | |
| approximate | | | | | | | | | | | | | |
| y = R32 approximate | | | 100-x-z | | | | 100-x-z | | | | 100-x -z | | |
| expression | | | | | | | | | | | | | |
| z = R1234(ze + yf) | | | −0.0114x² + 1.145x + 4.503 | | | | −0.01138x² + 1.1428x + 4.685 | | | | −0.011138x2 + 1.1428x + 4.685 | | |
| approximate | | | | | | | | | | | | | |
| | | r | a | b | c | r | a | b | c | r | a | b | c |

| | | | | | | | | | | | | |
|---|---|---|---|---|---|---|---|---|---|---|---|---|
| R1234(ze + yf) | 0 | −0.0114 | 1.1454 | 4.503 | 0.27 | −0.0114 | 1.1454 | 4.603 | 0.64 | −0.01138 | 1.1428 | 4.685 |
| approximate expression | 0.2 | −0.0114 | 1.1454 | 4.503 | 0.5 | −0.0114 | 1.1454 | 4.603 | 0.82 | −0.01138 | 1.1428 | 4.685 |
| when x = HFO-1132(E) | 0.27 | −0.0114 | 1.1454 | 4.503 | 0.64 | −0.01138 | 1.1428 | 4.685 | 1 | −0.01138 | 1.1428 | 4.685 |

| | | | |
|---|---|---|---|
| and r = yf/(rf + ze) | −0.0114x2 + 1.1454x + 4.503 | (0.0003861r² − 0.0002973r − | −0.01138x² + 1.1428x + 4.635 |
| | | 0.011348)x² + | |
| | | (−0.050193r² + 0.038649r + 1.1386)x+ | |

TABLE 23
Line segment OrPr

| Item | Unit | r | Oᵣ | O′ᵣ | Pᵣ | r | Oᵣ | O′ᵣ | Pᵣ | r | Oᵣ | O′ᵣ | Pᵣ |
|---|---|---|---|---|---|---|---|---|---|---|---|---|---|
| HFO-1132 (E) | mass % | 0 | 38.4 | 30.3 | 25.4 | 0.27 | 43.5 | 35.8 | 30.2 | 0.64 | 48.8 | 40.8 | 35.2 |
| R32 | mass % | | 0.0 | 2.5 | 5.0 | | 0.0 | 2.5 | 5.0 | | 0.0 | 2.5 | 5.0 |
| R1234(ze + yf) | mass % | | 61.6 | 67.2 | 69.6 | | 56.5 | 62.0 | 64.8 | | 51.2 | 56.7 | 59.8 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.0155x² + 0.3738x + | | | | −0.01195x² + 0.2581x + | | | | -0.0098x² + 0.1949x + | | |
| approximate | | | 70.108 | | | | 67.922 | | | | 65.043 | | |
| HFO-1132 (E) | mass % | 0.2 | 42.3 | 34.3 | 29.1 | 0.5 | 45.6 | 38.9 | 33.6 | 0.82 | 50.2 | 42.9 | 37.4 |
| R32 | mass % | | 0.0 | 2.5 | 5.0 | | 0.0 | 2.5 | 5.0 | | 0.0 | 2.5 | 5.0 |
| R1234(ze + yf) | mass % | | 57.7 | 63.2 | 65.9 | | 54.4 | 58.6 | 61.4 | | 49.2 | 54.6 | 57.6 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.01273 + 0.289x + | | | | −0.0082x² + 0.0672x + | | | | -0.0103x² + 0.2821x + | | |
| approximate | | | 68.286 | | | | 68.415 | | | | 61.466 | | |
| HFO-1132 (E) | mass % | 0.27 | 43.5 | 35.5 | 30.2 | 0.64 | 48.8 | 40.8 | 35.2 | 1 | 52.6 | 44.7 | 39.2 |
| R32 | mass % | | 0.0 | 2.5 | 5.0 | | 0.0 | 2.5 | 5.0 | | 0.0 | 2.5 | 5.0 |
| R1234(ze + yf) | mass % | | 56.5 | 62.0 | 64.8 | | 51.2 | 56.7 | 59.8 | | 47.4 | 52.8 | 55.8 |

| x = HFO-1132(E) | | x | | | | x | | | | x | | |
|---|---|---|---|---|---|---|---|---|---|---|---|---|
| approximate | | | | | | | | | | | | |
| y = R32 approximate | | 100-x-z | | | | 100-x-z | | | | 100-x-z | | |
| expression | | | | | | | | | | | | |
| z = R1234(ze + yf) | | −0.01195x² + 0.2581x + | | | | −0.0098x² + 0.1949x + | | | | -0.0103x² + 0.3192x + | | |
| approximate | | 67.922 | | | | 65.043 | | | | 59.125 | | |
| | r | a | b | c | r | a | b | c | r | a | b | c |
| R1234(ze + yf) | 0 | −0.0155 | 0.3738 | 70.108 | 0.27 | −0.01195 | 0.2581 | 67.922 | 0.64 | −0.0098 | 0.1949 | 65.043 |
| approximate expression | 0.2 | −0.01273 | 0.289 | 68.286 | 0.5 | −0.0082 | 0.0672 | 68.415 | 0.82 | −0.0103 | 0.2821 | 61.466 |
| when x = HFO-1132(E) | 0.27 | −0.01195 | 0.2581 | 67.922 | 0.64 | −0.0098 | 0.1949 | 65.043 | 1 | −0.0103 | 0.3192 | 59.125 |

| | | | |
|---|---|---|---|
| and r = yf/(rf + ze) | (−0.0102r² + 0 0159r − 0.0155)x² + | (−0.07485r² + 0.074r − 0.0265)x² + | (0.0077r² − 0.014r − 0.004)x² + |
| | (−0.0646r² − 0.4111r + 0.3738)x + | (4.7085r² − 4.555r + 1.1178)x + | (−0.7731r² + 1.6132r − 0.5209)x + |
| | (14.481r² − 12.006r + 70.108) | (−70.89r² + 56.729r + 57.773) | (19.074r² + 47.72r + 87.771) |

TABLE 24
Line segment PrQr

| Item | Unit | r | Pᵣ | P′ᵣ | Qᵣ | r | Pᵣ | P′ᵣ | Qᵣ | r | Pᵣ | P′ᵣ | Qᵣ |
|---|---|---|---|---|---|---|---|---|---|---|---|---|---|
| HFO-1132 (E) | mass % | 0 | 25.4 | 20.4 | 17.6 | 0.27 | 30.2 | 24.5 | 20.1 | 0.64 | 35.2 | 29.1 | 24.5 |
| R32 | mass % | | 5.0 | 10.0 | 17.9 | | 5.0 | 10.0 | 18.0 | | 5.0 | 10.0 | 18.2 |
| R1234(ze + yf) | mass % | | 69.6 | 69.5 | 64.5 | | 64.8 | 65.5 | 61.9 | | 53.8 | 60.9 | 57.3 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.2335x² + 10.695x2 − | | | | −0.0932x² + 4.9734x − | | | | −0.09x² + 5.6063x − | | |
| approximate | | | 51.4 | | | | 0.43 | | | | 26.04 | | |
| HFO-1132 (E) | mass % | 0.2 | 29.1 | 23.5 | 20.1 | 0.5 | 33.6 | 27.4 | 23.3 | 0.82 | 37.4 | 30.9 | 26.1 |
| R32 | mass % | | 5.0 | 10.0 | 18.0 | | 5.0 | 10.0 | 15.1 | | 5.0 | 10.0 | 19.2 |
| R1234(ze + yf) | mass % | | 65.9 | 66.5 | 61.9 | | 61.4 | 62.6 | 59.5 | | 57.6 | 59.1 | 55.7 |
| x = HFO-1132(E) | | | x | | | | x | | | | x | | |
| approximate | | | | | | | | | | | | | |
| y = R32 approximate | | | 100-x-z | | | | 100-x-z | | | | 100-x-z | | |
| expression | | | | | | | | | | | | | |
| z = R1234(ze + yf) | | | −0.1622x² + 8.4262x2 − | | | | −0.1135x² + 6.7306x2 − | | | | −0.0831x² + 5.4454x − | | |
| approximate | | | 41.92 | | | | 36.6 | | | | 29.81 | | |
| HFO-1132 (E) | mass % | 0.27 | 30.2 | 24.5 | 20.1 | 0.64 | 35.2 | 29.1 | 24.5 | 1 | 39.2 | 32.4 | 27.7 |
| R32 | mass % | | 5.0 | 10.0 | 18.0 | | 5.0 | 10.0 | 18.2 | | 5.0 | 10.9 | 18.2 |
| R1234(ze + yf) | mass % | | 64.8 | 65.5 | 61.9 | | 59.8 | 60.9 | 57.3 | | 55.8 | 57.6 | 54.1 |

| x = HFO-1132(E) | | x | | | | x | | | | x | | |
|---|---|---|---|---|---|---|---|---|---|---|---|---|
| approximate | | | | | | | | | | | | |
| y = R32 approximate | | 100-x-z | | | | 100-x-z | | | | 100.-x-z | | |
| expression | | | | | | | | | | | | |
| z = R1234(ze + yf) | | −0.11932x² + 4.9734x − | | | | −0.09x² + 5.6063x − | | | | −0.0878x² + 6.0198x − | | |
| approximate | | 0.43 | | | | 26.04 | | | | 45.3 | | |
| | r | a | b | c | r | a | b | c | r | a | b | c |
| R1234(ze + yf) | 0 | −0.2335 | 10.695 | −51.4 | 0.27 | −0.0932 | 4.9734 | −0.43 | 0.64 | −0.09 | 5.6063 | −26.04 |
| approximate expression | 0.2 | −0.1622 | 8.4262 | −41.92 | 0.5 | −0.1135 | 6.7306 | −36.6 | 0.32 | −9.0831 | 5.4454 | −29.81 |
| when x = HFO-1132(E) | 0.27 | −0.0932 | 4.9734 | −0.43 | 0.64 | −0.09 | 5.6063 | −26.04 | 1 | −0.0878 | 6.0198 | −45.3 |

| | | | |
|---|---|---|---|
| and r = yf/(rf + ze) | (2.3304r² − 0.1096r − 0.2335)x² + | (0.6922r² − 0.6213r + 0.0241)x² + | (−0.179r² + 0.2997r − 0.2085)x² + |
| | (−140.67r² + 16.791r + 10.695)x + | (−42.353r² + 40.252r − 2.8071)x + | (11.347r² − 17.461r + 12.133)x + |
| | (2019.7r² − 356.54r − 51.4) | (628.89r² − 641.51r + 126.93) | (−180.86r² + 243.12r − 107.55) |

### DESCRIPTION OF REFERENCE NUMERALS

1: Sample cell
2: High-speed camera
3: Xenon lamp
4: Collimating lens
5: Collimating lens
6: Ring filter

1. A composition comprising a refrigerant,
the refrigerant comprising trans-1,2-difluoroethylene (HFO-1132(E)), difluoromethane (R32), and 1,3,3,3-tetrafluoropropene (R1234ze).

2. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NB″, B″J, JI, IH, HG, and GK that connect the following 9 points:
point K (72.0, 0.0, 28.0),
point L (48.6, 18.1, 33.3),
point M (35.7, 36.7, 27.6),
point N (28.9, 51.6, 19.5),
point B″ (0.0, 51.4, 48.6),
point J (0.0, 39.1, 60.9),
point I (2.7, 36.5, 60.8),
point H (24.3, 18.0, 57.7), and
point G (50.9, 0.0, 49.1),
or on the line segments KL, LM, MN, NB″, JI, IH, and HG (excluding point B″, point J, point G, and point K),
the line segments LM, MN, NB″, B″J, JI, IH, and GK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment HG are represented by (x, 0.00319x²−0.9195x+38.567, −0.00319x²−0.0805x+61.433).

3. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MI, IH, HG, and GK that connect the following 6 points:
point K (72.0, 0.0, 28.0),
point L (48.6, 18.1, 33.3),
point M (35.7, 36.7, 27.6),
point I (2.7, 36.5, 60.8),
point H (24.3, 18.0, 57.7), and
point G (50.9, 0.0, 49.1),
or on the line segments KL, LM, MI, IH, and HG (excluding point G and point K),
the line segments LM, MI, IH, and GK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment HG are represented by (x, 0.00319x²−0.9195x+38.567, −0.00319x²−0.0805x+61.433).

4. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LH, HG, and GK that connect the following 4 points:
point K (72.0, 0.0, 28.0),
point L (48.6, 18.1, 33.3),
point H (24.3, 18.0, 57.7), and
point G (50.9, 0.0, 49.1),
or on the line segments KL, LH, and HG (excluding point G and point K),
the line segments LH and GK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment HG are represented by (x, 0.00319x²−0.9195x+38.567, −0.00319x²−0.0805x+61.433).

5. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, MN, NF, FE, ED, DC, and CK that connect the following 8 points:
point K (72.0, 0.0, 28.0),
point L (48.6, 18.1, 33.3),
point M (35.7, 36.7, 27.6),
point N (28.9, 51.6, 19.5),
point F (1.0, 51.5, 47.5),
point E (16.7, 36.5, 46.8),
point D (39.8, 18.1, 42.1), and
point C (67.6, 0.0, 32.4),
or on the line segments KL, LM, MN, NF, FE, ED, and DC (excluding point C and point K),
the line segments LM, MN, NF, FE, ED, and CK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment DC are represented by (x, 0.00257x²−0.9261x+50.903, −0.00257x²−0.0739x+49.097).

6. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LM, ME, ED, DC, and CK that connect the following 6 points:
point K (72.0, 0.0, 28.0),
point L (48.6, 18.1, 33.3),
point M (35.7, 36.7, 27.6),
point E (16.7, 36.5, 46.8),
point D (39.8, 18.1, 42.1), and
point C (67.6, 0.0, 32.4),
or on the line segments KL, LM, ME, ED, and DC (excluding point C and point K),
the line segments LM, ME, ED, and CK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment DC are represented by (x, 0.00257x²−0.9261x+50.903, −0.00257x²−0.0739x+49.097).

7. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by line segments KL, LD, DC, and CK that connect the following 4 points:
point K (72.0, 0.0, 28.0),
point L (48.6, 18.1, 33.3),
point D (39.8, 18.1, 42.1), and
point C (67.6, 0.0, 32.4),
or on the line segments KL, LD, and DC (excluding point C and point K),
the line segments LD and CK are straight lines,
coordinates (x,y,z) of the points on the line segment KL are represented by (x, 0.0114x²−2.1454x+95.397, −0.0114x²+1.1454x+4.603), and
coordinates (x,y,z) of the points on the line segment DC are represented by (x, 0.00257x²−0.9261x+50.903, −0.00257x²−0.0739x+49.097).

8. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by straight lines VR, RS, SB″, B″J, JI, and IV that connect the following 6 points:
point V (17.1, 24.2, 58.7),
point R (16.1, 36.6, 47.3),
point S (15.9, 51.4, 32.7),
point B″ (0.0, 51.4, 48.6),
point J (0.0, 39.1, 60.9), and
point I (2.7, 36.5, 60.8),
or on the straight lines VR, RS, SB″, JI, and IV (excluding point B″ and point J).

9. The composition according to claim 1,
wherein
when the mass % of HFO-1132(E), R32, and R1234ze based on their sum in the refrigerant is respectively represented by x, y, and z, coordinates (x,y,z) in a ternary composition diagram in which the sum of HFO-1132(E), R32, and R1234ze is 100 mass % are within the range of a figure surrounded by straight lines US, SF, and FU that connect the following 3 points:
point U (16.1, 37.1, 46.8),
point S (15.9, 51.4, 32.7), and
point F (1.0, 51.5, 47.5),
or on the straight lines US, SF, and FU.

10. The composition according to claim 1,
wherein the refrigerant further comprises R1234yf.

11. The composition according to claim 10,
wherein
when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf),
(1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣMᵣ, MᵣNᵣ, NᵣBᵣ″, Bᵣ″Jᵣ, JᵣIᵣ, IᵣHᵣ, HᵣGᵣ, and GᵣKᵣ that connect the following 9 points:
point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Iᵣ (−13.5r+2.7, 36.5, 13.5r+60.8),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082),
or on the line segments KᵣLᵣ, LᵣMᵣ, MᵣNᵣ, NᵣBᵣ″, JᵣIᵣ, IᵣHᵣ, and HᵣGᵣ (excluding point Bᵣ″, point Jᵣ, point Gᵣ, and point Kᵣ),
the line segments LᵣMᵣ, MᵣNᵣ, NᵣBᵣ″, Bᵣ″Jᵣ, JᵣIᵣ, IᵣHᵣ, and GᵣKᵣ are straight lines,
coordinates (x,y,z) of the points on the line segment KᵣLᵣ are represented by (x, 100-x-z, −0.0114x²+1.1454x+4.503), and
coordinates (x,y,z) of the points on the line segment HᵣGᵣ are represented by (x, 100-x-z, (0.00965r²−0.0024r−0.00319)x²+(−0.6153r²+0.0221r−0.0805)x+(11.593r²+10.251r+61.433)),
(2) if 1>r>0.2, coordinates (x,y,z) in the ternary composition diagram are within the range of a figure surrounded by line segments KᵣLᵣ, LᵣMᵣ, MᵣNᵣ, NᵣBᵣ″, Bᵣ″Jᵣ, JᵣHᵣ, HᵣGᵣ, and GᵣKᵣ that connect the following 8 points:
point Kᵣ (72.0, 0.0, 28.0),
point Lᵣ (−0.0618r²−0.0675r+48.612, 0.0618r²+0.0675r+18.088, 33.3),
point Mᵣ (−0.0618r²−0.0675r+35.712, 0.0618r²+0.0675r+36.688, 27.6),
point Nᵣ (−0.0618r²−0.0675r+28.912, 0.0618r²+0.0675r+51.588, 19.5),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082),
or on the line segments KᵣLᵣ, LᵣMᵣ, MᵣNᵣ, NᵣBᵣ″, JᵣHᵣ, and HᵣGᵣ (excluding point Bᵣ″, point Jᵣ, point Gᵣ, and point Kᵣ), and
the line segments LᵣMᵣ, MᵣNᵣ, NᵣBᵣ″, Bᵣ″Jᵣ, JᵣHᵣ, and GᵣKᵣ are straight lines, wherein
(2-1) if 0.27≥r>0.2,
coordinates (x,y,z) of the points on the line segment KᵣLᵣ are represented by (x, 100-x-z, −0.0114x²+1.1454x+4.503), and
coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r²+10.251r+61.433)), and
(2-2) if 0.64≥r>0.27,
coordinates (x,y,z) of the points on the line segment KᵣLᵣ are represented by (x, 100-x-z, (0.0003861r²−0.0002973r−0.011348)x²+(−0.050193r²+0.038649r+1.1386)x+(1.583r²−1.2189r+4.8167)), and
coordinates (x,y,z) of the points on the line segment HᵣGᵣ are represented by (x, 100-x-z, (0.011147r²−0.010278r−0.00111674)x²+(−0.8771r²+0.6728r−0.2371)x+(12.661r²+0.7382r+63.924)), and
(3) if 1>r>0.64,
coordinates (x,y,z) of the points on the line segment KᵣLᵣ are represented by (x, 100-x-z, −0.01138x²+1.1428x+4.685), and
coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)).

12. The composition according to claim 10,
wherein
when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf), coordinates (x,y,z) in a ternary composition diagram whose first vertex represents HFO-1132(E), second vertex represents R32, and third vertex represents the sum of 1234ze and R1234yf are within the range of a figure surrounded by line segments KᵣLᵣ, LᵣHᵣ, HᵣGᵣ, and GᵣKᵣ that connect the following 4 points:
point Kᵣ (72.0, 0.0, 28.0),
point Lᵣ (−0.0618r²−0.0675r+48.612, 0.0618r²+0.0675r+18.088, 33.3),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082),
or on the line segments KᵣLᵣ, LᵣHᵣ, and HᵣGᵣ (excluding point Gᵣ and point Kᵣ), and
the line segments LᵣHᵣ and GᵣKᵣ are straight lines,
wherein
(2-1) if 0.27≥r>0.2,
coordinates (x,y,z) of the points on the line segment KᵣLᵣ are represented by (x, 100-x-z, −0.0114x²+1.1454x+4.503), and
coordinates (x,y,z) of the points on the line segment HᵣGᵣ are represented by (x, 100-x-z, ((0.00965r²−0.0024r−0.00319)x²+(−0.6153r²+0.0221r−0.0805)x+(11.593r²+10.251r+61.433)),
(2-2) if 0.64≥r>0.27,
coordinates (x,y,z) of the points on the line segment KᵣLᵣ are represented by (x, 100-x-z, (0.0003861r²−0.0002973r−0.011348)x²+(−0.050193r²+0.038649r+1.1386)x+(1.583r²−1.2189r+4.8167)), and
coordinates (x,y,z) of the points on the line segment HᵣGᵣ are represented by (x, 100-x-z, (0.011147r²−0.010278r−0.00111674)x²+(−0.8771r²+0.6728r−0.2371)x+(12.661r²+0.7382r+63.924)), and
(2-3) if 1>r>0.64,
coordinates (x,y,z) of the points on the line segment KᵣLᵣ are represented by (x, 100-x-z, −0.01138x²+1.1428x+4.685), and
coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)).

13. The composition according to claim 10,
wherein
when the mass % of HFO-1132(E) is x, the mass % of R32 is y, and the mass % of the sum of R1234ze and R1234yf is z, based on the sum of HFO-1132(E), R32, R1234ze, and R1234yf in the refrigerant, and when r=R1234yf/(R1234ze+R1234yf),
(1) if 0.2≥r>0, coordinates (x,y,z) in a ternary composition diagram whose first vertex represents HFO-1132(E), second vertex represents R32, and third vertex represents the sum of 1234ze and R1234yf are within the range of a figure surrounded by line segments VᵣRᵣ, RᵣSᵣ, SᵣBᵣ″, Bᵣ″Jᵣ, JᵣIᵣ, and IᵣVᵣ that connect the following 6 points:
point Vᵣ (−4.2328r²+14.847r+17.1, 14.815r²−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, −0.491r²−4.6129r+32.703),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Iᵣ (−13.5r+2.7, 36.5, 13.5r+60.8),
or on the line segments VᵣRᵣ, RᵣSᵣ, SᵣBᵣ″, JᵣIᵣ, and IᵣVᵣ (excluding point Bᵣ″ and point Jᵣ), and
the line segments VᵣRᵣ, RᵣSᵣ, SᵣBᵣ″, Bᵣ″Jᵣ, JᵣIᵣ, and IᵣVᵣ are straight lines, (2) if 0.27≥r>0.2, coordinates (x,y,z) in the ternary composition diagram are within the range of a figure surrounded by line segments VᵣRᵣ, RᵣSᵣ, SᵣBᵣ″, Bᵣ″Jᵣ, and JᵣVᵣ that connect the following 5 points:
point Vᵣ (−4.2328r²+14.847r+17.1, 14.815r²−26.963r+24.2, −10.5822r²+12.116r+58.7),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point Bᵣ″ (0, −0.2268r²+0.2922r+51.422, 0.0083r²−0.1392r+82.165), and
point Jᵣ (0, 0.9705r²−13.268r+39.105, −0.9705r²+13.268r+60.895),
or on the line segments VᵣRᵣ, RᵣSᵣ, SᵣBᵣ″, and JᵣVᵣ (excluding point Bᵣ″ and point Jᵣ), and
the line segments VᵣRᵣ, RᵣSᵣ, SᵣBᵣ″, Bᵣ″Jᵣ, and JᵣVᵣ are straight lines,
(3) if 0.64≥r>0.27, coordinates (x,y,z) in the ternary composition diagram are within the range of a figure surrounded by line segments VᵣQᵣ, QᵣRᵣ, RᵣSᵣ, SᵣBᵣ″, Bᵣ″Jᵣ, JᵣHᵣ, and HᵣVᵣ that connect the following 7 points:
point Vᵣ (113.4r²−64.271r+29.887, −64.63r²+23.678r+16.318, −48.77r²+40.5931r+53.795),
point Qᵣ (−6.2112r²+15.652r+17.027, 0.7554r²−0.1469r+17.985, 5.4558r²−15.5051r+64.988),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895), and
point Hᵣ (−0.4195r²−12.988r+24.311, 0.0618r²+0.0675r+17.988, 0.3577r²+12.9205r+57.701),
or on the line segments VᵣQᵣ, QᵣRᵣ, RᵣSᵣ, SᵣBᵣ″, JᵣHᵣ, and HᵣVᵣ (excluding point Bᵣ″ and point Jᵣ), and
the line segments VᵣRᵣ, QᵣRᵣ, RᵣSᵣ, SᵣBᵣ″, Bᵣ″Jᵣ, JᵣHᵣ, and HᵣVᵣ are straight lines, and
(4) if 1.0>r>0.64, coordinates (x,y,z) in the ternary composition diagram are within the range of a figure surrounded by line segments OᵣPᵣ, PᵣQᵣ, QᵣRᵣ, RᵣSᵣ, SᵣBᵣ″, Bᵣ″Jᵣ, JᵣHᵣ, HᵣGᵣ, and GᵣKᵣ that connect the following 9 points:
point Oᵣ (−3.0864r²+15.617r+40.069, 0.0, 3.0864r²−15.617r+59.931),
point Pᵣ (−6.1728r²+21.235r+24.138, 5.0, 6.1728r²−21.235r+70.862),
point Qᵣ (8.8889r+18.811, 18.2, −8.8889r+62.989),
point Rᵣ (−1.3862r²+7.8917r+16.089, 0.0937r²+0.1466r+36.581, 1.2925r²−8.0383r+47.33),
point Sᵣ (−0.3578r²+4.1741r+15.894, −0.1332r²+0.4388r+51.403, 0.491r²−4.6129r+32.703),
point Bᵣ″ (0, −0.2268r²+0.2922r+51.422, 0.0083r²−0.1392r+82.165),
point Jᵣ (0, 0.9705r²−13.268r+39.105, −0.9705r²+13.268r+60.895),
point Hᵣ (−0.4195r²−12.988r+24.311, 0.0618r²+0.0675r+17.988, 0.3577r²+12.9205r+57.701), and
point Gᵣ (−0.1892r²−11.155r+50.918, 0.0, 0.1892r²+11.155r+49.082),
or on the line segments OᵣPᵣ, PᵣQᵣ, QᵣRᵣ, RᵣSᵣ, SᵣBᵣ″, JᵣHᵣ, and HᵣGᵣ (excluding point Oᵣ, point Bᵣ″, point Jᵣ, and point Gᵣ),
the line segments QᵣRᵣ, RᵣSᵣ, SᵣBᵣ″, Bᵣ″Jᵣ, and JᵣHᵣ are straight lines,
coordinates (x,y,z) of the points on the line segment OᵣPᵣ are represented by (x, 100-x-z, (0.0077r²−0.014r−0.004)x²+(−0.7731r²+1.6132r−0.5209)x+(19.074r²−47.72r+87.771)),
coordinates (x,y,z) of the points on the line segment PᵣQᵣ are represented by (x, 100-x-z, (−0.179r²+0.2997r−0.2085)x²+(11.347r²−17.461r+12.133)x+(−180.86r²+243.12r−107.55)), and
coordinates (x,y,z) of the points on the line segment HᵣGᵣ are represented by (x, 100-x-z, (0.0003r²−0.0006r−0.0029)x²+(0.0062r²−0.1212r−0.0907)x+(2.1759r²+15.588r+61.137)).

14. The composition according to claim 1, for use as a working fluid for a refrigerating machine, wherein the composition further comprises a refrigeration oil.

15. The composition according to claim 1, for use as an alternative refrigerant for R410A.

16. Use of the composition according to claim 1 as an alternative refrigerant for R410A.

17. A refrigerating machine comprising the composition according to claim 1 as a working fluid.

18. A method for operating a refrigerating machine, comprising the step of circulating the composition according to claim 1 as a working fluid in a refrigerating machine.
